(19) United States
(12) Patent Application Publication
(10) Pub. No.: US 2005/0200875 A1
(43) Pub. Date: Sep. 15, 2005

(54) Print system, print data editing unit and print apparatus

(75) Inventors: Masahiro Sugimoto, Nagoya-shi (JP); Satoru Moriyama, Iwakura-shi (JP)

Correspondence Address: OLIFF & BERRIDGE, PLC, P.O. BOX 19928, ALEXANDRIA, VA, 22320, US

(73) Assignee: Brother Kogyo Kabushiki Kaisha, Nagoya-shi (JP)

(21) Appl. No.: 11/068,870

(22) Filed: Mar. 2, 2005

(30) Foreign Application Priority Data
Mar. 12, 2004 (JP) 2004-070248

(51) Int. Cl. G06F 15/00; H04N 1/46

(52) U.S. Cl. 358/1.13; 358/537

(57) ABSTRACT

If a signal of a unit detecting switch provided at a roll paper unit setting position in a print apparatus is detected and the value indicated by the detected signal is not stored in a medium information memory area, it is determined that it is a new roll paper unit and shortage request information is transmitted to a personal computer. If medium information is received, a medium information acquisition processing is carried out. In this medium information acquisition processing, received medium information is stored in the medium information memory area.

### CROSS-REFERENCE TO RELATED APPLICATION

This application claims priority from JP 2004-070248 filed Mar. 12, 2004, the entire disclosure of which is incorporated herein by reference thereto.

### BACKGROUND

The disclosure relates to a print system, print data editing unit and print apparatus and more particularly to a print system, print data editing unit and print apparatus capable of adding and changing information concerning a print medium for use in the print apparatus.

Conventionally, in a first case, a print apparatus is provided with a detecting means for detecting the type of a print medium so as to control the print position, print energy and the like depending on the type of a print medium detected by the detecting means. For example, a tape print apparatus for printing a tape loaded on a cassette tape is provided with a plurality of press-down type switches and the tape cassette includes some holes corresponding to the positions of the switches. When the tape cassette is set up, switches located at portions having a hole are not pressed down and switches at portions having no hole are pressed down. The type of the tape cassette, that is, the type of the tape is detected depending on a combination of switches pressed down. In the print apparatus for printing a cut paper, a setting portion for the cut papers is provided with a sensor so as to detect the size of the paper.

In a second case, there has been well known a stamp creating unit in which medium information of a stamp unit which is a processing medium is registered like the print apparatus so as to control the position and the like for plate making depending on the type of the stamp. Japanese Patent Application Laid-Open No. HEI 11-277859 has proposed a stamp creating unit in which, when a new stamp is added, information (number of dots indicating print surface area of the new stamp) is inputted into a personal computer for creating print surface data for plate making for the stamp and registered in the stamp creating unit.

### SUMMARY

Thus, in the first case, there is a problem that if printing is done on a printing object medium not registered in the print apparatus, the print cannot be achieved under an image expected when print data is created or the print itself cannot be achieved.

However, the stamp creating unit disclosed in the second case has a problem that although it allows a new stamp to be used, information of the new stamp needs to be inputted into a personal computer.

The disclosure has been achieved to solve the above-described problems and intends to provide a print system, print data editing unit and print apparatus for easily registering medium information concerning a new print medium into the print apparatus.

To achieve the above-described object, according to a first aspect, there is provided a print system in which a print data editing unit for creating print data for a print apparatus to print and the print apparatus are connected, wherein the print data editing unit comprises an editing unit side medium information memory that stores medium information concerning a printing object medium to be printed upon by the print apparatus; and an editing unit side medium information transmitting device that transmits the medium information stored in the editing unit side medium information memory to the print apparatus, and the print apparatus comprises a print apparatus side medium information memory that stores the medium information; a print apparatus side medium information receiving device that receives the medium information transmitted from the editing unit side medium information transmitting device; and a medium information memory controller that controls the print apparatus side medium information memory to store the medium information received by the print apparatus side medium information receiving device.

According to a second aspect, there is provided a print apparatus connected to a print data editing unit for creating print data for the print apparatus to print, comprising a print apparatus side medium information memory that stores medium information; a print apparatus side medium information receiving device that receives the medium information transmitted from the print data editing unit; and a medium information memory controller that stores the medium information received by the print apparatus side medium information receiving device in the print apparatus side medium information memory.

According to a third aspect, there is provided a print data editing unit connected to a print apparatus for creating print data for the print apparatus to print, comprising an editing unit side medium information memory that stores medium information concerning a printing object medium to be printed upon by the print apparatus; and an editing unit side medium information transmitting device that transmits the medium information stored in the editing unit side medium information memory to the print apparatus.

According to a fourth aspect, there is provided a print apparatus comprising a medium information memory that stores medium information concerning a printing object medium to be printed upon by the print apparatus; a printing object medium detector that detects the type of a printing object medium loaded on the print apparatus; detection medium discriminating means for determining whether the medium information of the printing object medium of a type detected by the printing object medium detecting means is stored in the medium information memory; an input device capable of inputting the medium information; an inputted medium information memory controller that controls storing an inputted medium information that is a medium information inputted by the input device into the medium information memory; and an input controller that, when it is determined that the medium information is not stored by the detection medium discriminating means, actuates the input device.

According to a fifth aspect, there is provided a print apparatus comprising a medium information memory that stores medium information concerning a printing object medium to be printed upon by the print apparatus; a printing object medium detector that detects the type of a printing object medium loaded on the print apparatus; detection medium discriminating means for determining whether the medium information of the printing object medium of a type detected by the printing object medium detector is stored in the medium information memory; a connection information memory that stores connection information for connecting to a server providing the medium information; a connection to the server using the connection information stored in the connection information memory; medium information acquiring means, that is connected to the server by the connection, for acquiring the medium information; and a short medium information acquisition controller that, when it is determined that at least some medium information is not stored by the detection medium discriminating means, controls acquiring short medium information from the server with the medium information acquiring means.

According to a sixth aspect, there is provided a print apparatus comprising a medium information memory that stores medium information concerning a printing object medium to be printed upon by the print apparatus; a printing object medium detector that detects the type of a printing object medium loaded on the print apparatus; detection medium discriminating means for determining whether the medium information of the printing object medium of a type detected by the printing object medium detector is stored in the medium information memory; a connection information memory that stores connection information for connecting to a server providing the medium information; a connection to the server using the connection information stored in the connection information memory; medium information acquiring means, that is connected to the server by the connection, for acquiring the medium information; and an all item medium information acquisition controller that, when it is determined that the medium information is not stored by the detection medium discriminating means, controls acquiring all pieces of the medium information from the server by the medium information acquiring means.

According to a seventh aspect, there is provided a print system in which a print data editing unit for creating print data for a print apparatus to print and the print apparatus are connected and further the print data editing unit and a server are connected, wherein the print data editing unit comprises an editing unit side medium information memory that stores medium information concerning a printing object medium to be printed upon by the print apparatus; and an editing unit side medium information transmitting device transmits the medium information stored in the editing unit side medium information memory to the print apparatus, and the print apparatus comprises a print apparatus side medium information memory that stores the medium information; a print apparatus side medium information receiving device that receives the medium information transmitted from the editing unit side medium information transmitting device; a medium information memory controller that controls the print apparatus side medium information memory to store the medium information received by the print apparatus side medium information receiving device; a printing object medium detector that detects the type of a printing object medium loaded on the print apparatus; detection medium discriminating means for determining whether the medium information of the printing object medium of a type detected by the printing object medium detector is stored in the print apparatus side medium information memory; and a shortage request information transmitting device that, when it is determined that the medium information is not stored by the detection medium discriminating means, transmits short medium information requesting short medium information that is the medium information not stored in the print apparatus side medium information memory to the print data editing unit, and the print data editing unit further comprises a shortage request information receiving device that receives the shortage request information transmitted from the shortage request information transmitting device; extracting means for extracting the short medium information requested by the shortage request information received by the shortage request information receiving device from the medium information stored in the editing unit side medium information memory, a short medium information transmission controller that controls transmission of the medium information extracted by the extracting means to the print apparatus side medium information receiving device by the editing unit side medium information transmitting device; a connection information memory that stores connection information for connecting the medium information to a server; a connection to the server using the connection information stored in the connection information memory means; medium information acquiring means, that is connected to the server by the connection, for acquiring the medium information; and a short medium information acquisition controller that, when the short medium information is not extracted by the extracting means, controls acquiring the short medium information from the server by the medium information acquiring means.

According to an eighth aspect, there is provided a print system in which a print data editing unit for creating print data for a print apparatus to print and the print apparatus are connected and further the print data editing unit and a server are connected, wherein the print data editing unit comprises an editing unit side medium information memory that stores medium information concerning a printing object medium to be printed upon by the print apparatus; and an editing unit side medium information transmitting device that transmits the medium information stored in the editing unit side medium information memory to the print apparatus, and the print apparatus comprises a print apparatus side medium information memory that stores the medium information; a print apparatus side medium information receiving device that receives the medium information transmitted from the editing unit side medium information transmitting device; a medium information memory controller that controls storing, in the print apparatus side medium information memory, of the medium information received by the print apparatus side medium information receiving device; a printing object medium detector that detects the type of a printing object medium loaded on the print apparatus; detection medium discriminating means for determining whether the medium information of a printing object medium of a type detected by the printing object medium detector is stored in the print apparatus side medium information memory; and a shortage request information transmitting device that, when it is determined that the medium information is not stored in the print apparatus side medium information by the detection medium discriminating means, transmits short medium information requesting short medium information that is the medium information not stored to the print data editing unit, and the print data editing unit further comprises a shortage request information receiving device that receives the shortage request information transmitted from the shortage request information transmitting device; extracting means for extracting the short medium information requested by the shortage request information received by the shortage request information receiving device from the medium information stored in the editing unit side medium information memory; a short medium information transmission controller that controls transmitting the medium information extracted by the extracting means to the print apparatus side medium information receiving device by the editing unit side medium information transmitting device; a connection information memory that stores connection information for connecting to the server providing the medium information; a connection to the server using the connection information stored in the connection information memory means; medium information acquiring means, that is connected to the server by the connection, for acquiring the medium information; and an all item medium information acquisition controller that, when the short medium information is not extracted by the extracting means, controls acquiring all pieces of the medium information from the server by the medium information acquiring means.

According to a ninth aspect, there is provided a print data editing unit to be used in a system in which a print data editing unit for creating print data for a print apparatus to print and the print apparatus are connected and further the print data editing unit and a server are connected, comprising an editing unit side medium information memory that stores medium information concerning a printing object medium to be printed upon by the print apparatus; an editing unit side medium information transmitting device that transmits the medium information stored in the editing unit side medium information memory to the print apparatus; a shortage request information receiving device that receives shortage request information requesting short medium information, that is a medium information transmitted from the print apparatus and is not stored in the print apparatus; extracting means for extracting the short medium information requested by the shortage request information received by the shortage request information receiving device from the medium information stored in the editing unit side medium information memory; a short medium information transmission controller that controls transmitting the medium information extracted by the extracting means to the print apparatus by the editing unit side medium information transmitting device; a connection information memory that stores connection information for connecting to the server providing the medium information; a connection to the server using the connection information stored in the connection information memory; medium information acquiring means, that is connected to the server by the connection, for acquiring the medium information; and a short medium information acquisition controller that, when the short medium information is not extracted by the extracting means, controls acquiring the short medium information from the server by the medium information acquiring means.

According to a tenth aspect, there is provided a print data editing unit to be used in a system in which the print data editing unit, for creating print data for a print apparatus to print, and the print apparatus are connected and further the print data editing unit and a server are connected, the print data editing unit comprising an editing unit side medium information memory that stores medium information concerning a printing object medium to be printed upon by the print apparatus; an editing unit side medium information transmitting device that transmits the medium information stored in the editing unit side medium information memory to the print apparatus; a shortage request information receiving device that receives shortage request information requesting short medium information, that is a medium information transmitted from the print apparatus and is not stored in the print apparatus; extracting means for extracting the short medium information requested by the shortage request information received by the shortage request information receiving device from the medium information stored in the editing unit side medium information memory; a short medium information transmission controller that controls transmitting the medium information extracted by the extracting means to the print apparatus by the editing unit side medium information transmitting device; a connection information memory that stores connection information for connecting to the server providing the medium information; a connection to the server using the connection information stored in the connection information memory; medium information acquiring means, that is connected to the server by the connection, for acquiring the medium information; and an all item medium information acquisition controller that, when the short medium information is not extracted by the extracting means, controls acquiring all pieces of the medium information from the server with the medium information acquiring means.

According to an eleventh aspect, there is provided a print apparatus to be used in a system in which the print apparatus and server are connected, comprising a medium information memory that stores medium information concerning a printing object medium to be printed by the print apparatus; a printing object medium detector that detects the type of a printing object medium loaded on the print apparatus; detection medium discriminating means for determining whether the medium information of the printing object medium of a type detected by the printing object medium detector is stored in the medium information memory; a connection information memory that stores connection information for connecting to the server providing the medium information; a connection to the server using the connection information stored in the connection information memory; medium information acquiring means, that is connected to the server by the connection, for acquiring the medium information; and a short medium information acquisition controller that, when it is determined that at least some medium information is not stored by the detection medium discriminating means, controls acquiring the short medium information from the server with the medium information acquiring means.

According to a twelfth aspect, there is provided a print apparatus to be used in a system in which the print apparatus and server are connected, comprising a medium information memory that stores medium information concerning a printing object medium to be printed upon by the print apparatus; a printing object medium detector that detects the type of a printing object medium loaded on the print apparatus; detection medium discriminating means for determining whether the medium information of the printing object medium of a type detected by the printing object medium detector is stored in the medium information memory; a connection information memory that stores connection information for connecting to the server providing the medium information; a connection to the server using the connection information stored in the connection information memory; medium information acquiring means, that is connected to the server by the connection, for acquiring the medium information; and an all item medium information acquisition controller that, when it is determined that the medium information is not stored by the detection medium discriminating means, controls acquiring all pieces of the medium information from the server by the medium information acquiring means.

### BRIEF DESCRIPTION OF THE DRAWINGS

Exemplary embodiments will be described below in detail with reference to the accompanying drawings in which:

FIG. 1 is a system configuration diagram of the print system of the first embodiment;

FIG. 2 is a perspective view showing a condition in which the cover of the print apparatus is opened;

FIG. 3 is a perspective view of a roll paper unit to be printed by the print apparatus;

FIG. 4 is a sectional view of the print apparatus;

FIG. 5 is a block diagram showing the electric configuration of the print apparatus;

FIG. 6 is a schematic view showing the memory area of RAM in the print apparatus;

FIG. 7 is a block diagram showing the electric configuration of a personal computer;

FIG. 8 is a schematic diagram showing the memory area in HDD of the personal computer;

FIG. 9 is a schematic diagram showing the memory area in RAM of the personal computer;

FIG. 10 is a schematic diagram of a medium information memory area;

FIG. 11 is an image diagram of a new roll paper unit information input screen;

FIG. 12 is a flowchart of the main processing of the print apparatus;

FIG. 13 is a flowchart of print processing to be carried out in the main processing of the print apparatus;

FIG. 14 is a flowchart of the medium information acquisition processing to be carried out in the main processing of the print apparatus;

FIG. 15 is a flowchart of the main processing in the personal computer;

FIG. 16 is a flowchart of total check processing to be carried out in the main processing of the personal computer;

FIG. 17 is a flowchart for shortage request processing to be carried out in the main processing of the personal computer;

FIG. 18 is a flowchart for print processing to be carried out in the main processing of the personal computer;

FIG. 19 is a flowchart of the shortage request processing to be carried out in the main processing of the personal computer according to a first modification of the first embodiment;

FIG. 20 is a flowchart of medium information acquisition processing to be carried out in the main processing of the print apparatus according to a sixth modification of the first embodiment;

FIG. 21 is a system configuration diagram of a print system according to the second embodiment;

FIG. 22 is a block diagram showing the electric configuration of the print apparatus according to the second embodiment;

FIG. 23 is a flowchart of the main processing of the print apparatus according to the second embodiment; and

FIG. 24 is a flowchart of server connection processing to be carried out in the main processing of the print apparatus according to the second embodiment.

### DETAILED DESCRIPTION OF EMBODIMENTS

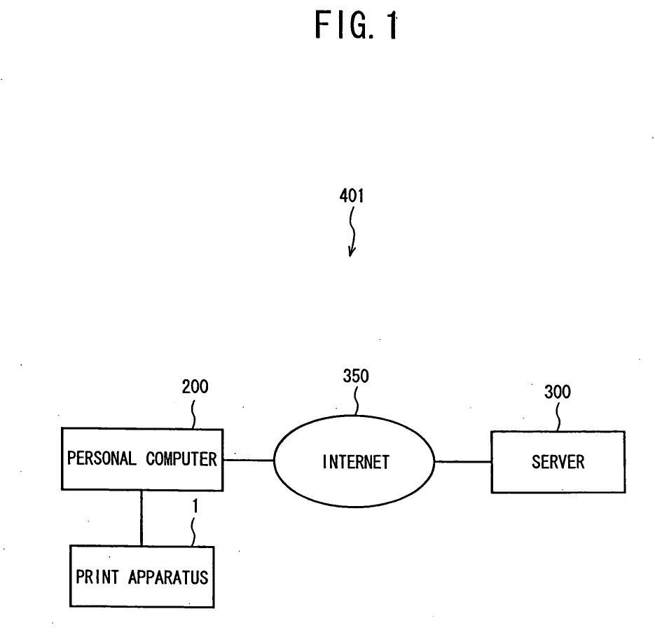

Hereinafter, the embodiments will be described with reference to the accompanying drawings. The first embodiment will be described by using, for example, a personal computer 200, to which a print apparatus 1 is connected, as a “print data editing unit”. As shown in FIG. 1, the print apparatus 1 is connected to the personal computer 200 and the personal computer 200 is connected to a server 300 through the Internet 350. According to the first embodiment, print data created by the personal computer 200 is printed by the print apparatus 1. The server 300 is a server through which a manufacturer of the print apparatus 1 provides information about the tape to be printed by the print apparatus 1.

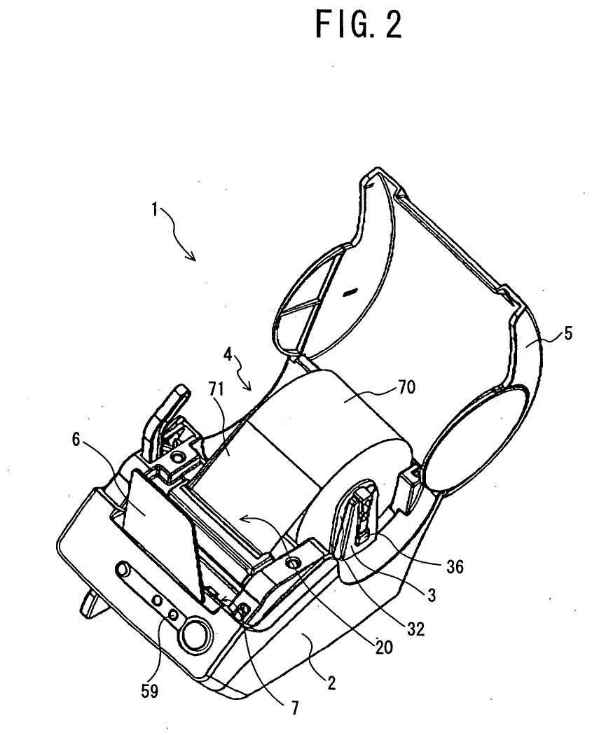

Next, the print apparatus 1 of the first embodiment will be described with reference to FIGS. 2 to 6. As shown in FIG. 2, in the print apparatus 1, a cover 5 is journaled rotatably to a lower case 2. A roll paper unit setting mechanism 4, for setting a roll paper unit 70 loaded with a tape 71, and a print mechanism 20 are provided inside the lower case 2. Thus, by opening the cover 5, the roll paper unit 70 can be replaced. The roll paper unit setting mechanism 4 is provided toward the rear inside of the lower case 2 and the print mechanism 20 is provided forward thereof A tape discharge port 7 is provided toward the front in the top face of the lower case 2 and a tape receiver 6 is erected forward of the tape discharge port 7. A V-shaped unit support 3 is provided on the right side face (as shown in FIG. 2, i.e., from the position of facing the print apparatus) of the lower case 2 in the roll paper unit setting mechanism 4. The tape 71, loaded on the roll paper unit 70 set in the roll paper unit setting mechanism 4, is printed upon by the print mechanism 20 and discharged from the tape discharge port 7. An error lamp 59, various kinds of lamps and various kinds of operation buttons are provided on the forward portion of the top face of the lower case 2.

The print mechanism 20 includes a thermal head (not shown) and a platen roller (not shown). The tape 71 is carried such that it is nipped by the platen roller and the thermal head. By selectively and intermittently supplying the heat generating elements of the thermal head with power, a desired image is formed in a predetermined region of the tape surface.

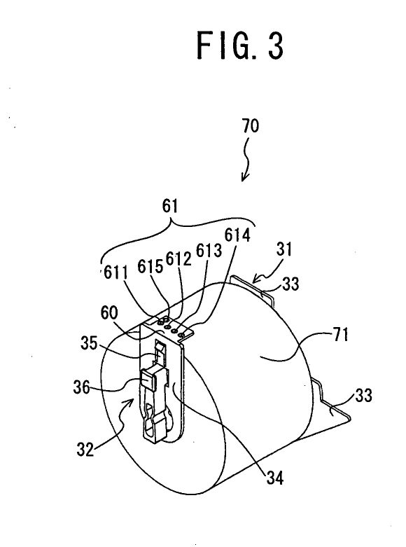

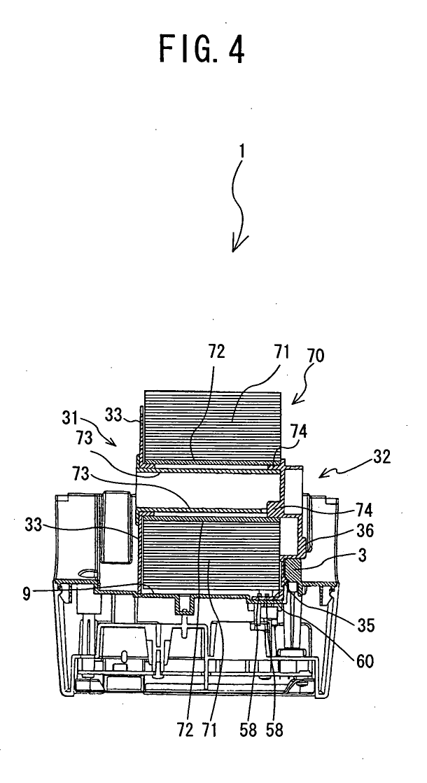

Next, the roll paper unit 70 will be described with reference to FIGS. 3 and 4. In the roll paper unit 70, the tape 71 is wound around a roll shaft 72 and nipped between a first nipping member 31 and a second nipping member 32. The first nipping member 31 comprises a bearing 73 which is a substantially cylindrical member for holding the tape 71 and is tightly inserted into the inside of the roll shaft 72. A guide 33, which is a sheet-like member, supports the roll of the tape 71 so as to prevent it from getting out of alignment.

The second nipping member 32 comprises a guide 34, which is a sheet-like member, that supports the roll of the tape 71 so as to prevent it from getting out of alignment, a bearing 74, which is a substantially cylindrical member for holding the tape 71, that is tightly inserted into the inside of the roll shaft 72, a convex portion 36 which is inserted into and fits the concave portion of the unit supporter 3 of the roll paper unit setting mechanism 4, and an engagement pawl 35 for fixing to the lower case 2.

A medium type indicating portion 60 is provided on the guide 34 of the second nipping member 32. The medium type indicating portion 60 is a substantially rectangular plate containing identification holes 61 for indicating the type of printing object medium. As shown in FIG. 3, it is possible to provide two parallel rows of four identification holes extending in the winding direction of the tape 71. The two rows are arrayed in the width direction of the tape 71. As a result, a total of eight identification holes 61 can be provided (only five are shown in FIG. 3). As partially shown in FIG. 4, two rows (arrayed in the width direction of the tape 71), each row having four press-down type unit detection switches 58 (extending in the winding direction of the tape 71) can also be provided for a possible total of eight unit detection switches 58 at positions opposing the medium type indicating portion 60 when the roll paper unit 70 is set. The detection switches 58 are on the bottom face 9 of the lower case 2. Then, if the roll paper unit 70 is set in the roll paper unit setting mechanism 4, the unit detection switches 58 at the positions in which the identification holes 61 are provided fit into the identification holes 61 and the unit detection switches 58 at positions at which no identification holes 61 are provided are pressed down.

The positions in which the identification holes 61 are provided differ depending on the type of print medium, indicating the identification information of the medium type. Because up to eight identification holes 61 can be provided, 2⁸ types, that is, 256 types of the mediums can be indicated. In the example shown in FIG. 3, four identification holes, 611, 612, 613, 614 are provided along an outer side and an identification hole 615 is provided on an inner side as viewed in FIG. 3.

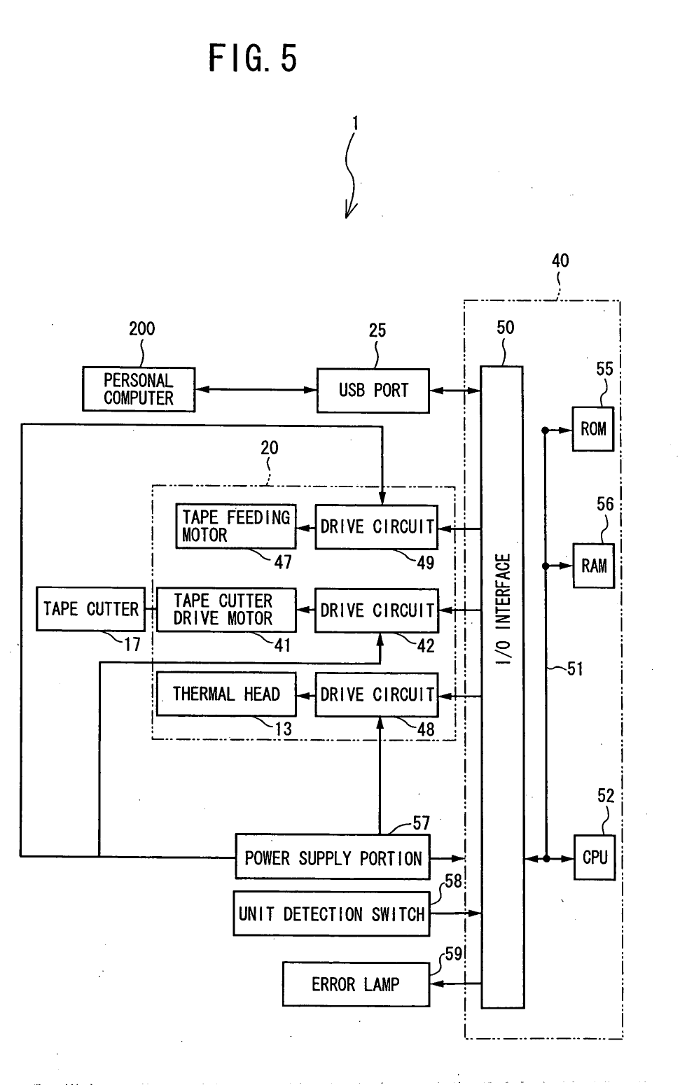

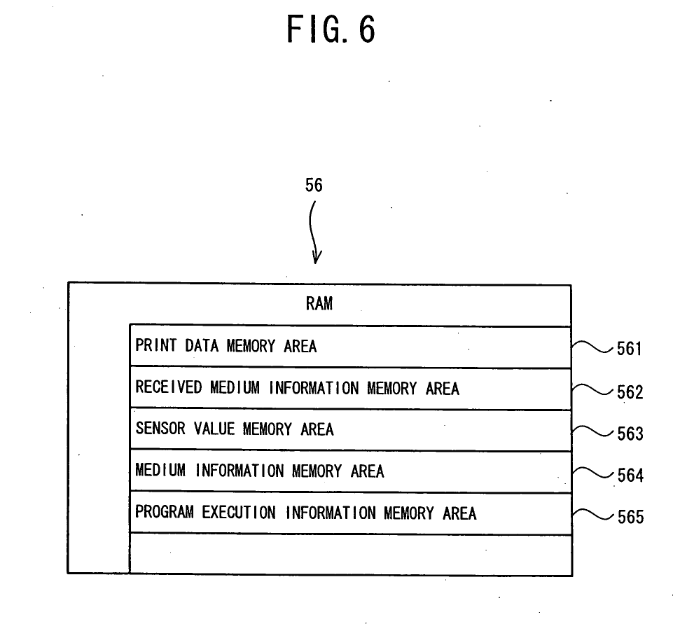

Next, the electronic configuration of the print apparatus 1 will be described with reference to FIGS. 5 and 6. As shown in FIG. 5, the control portion 40 comprises a CPU 52 for controlling respective components of the print apparatus 1, an I/O interface 50 connected to the CPU 52 through a data bus 51, a ROM 55 and a RAM 56.

A drive circuit 48 for driving the thermal head 13, a drive circuit 42 for driving a tape cutter drive motor 41 for operating the tape cutter 17, a drive circuit 49 for driving a tape feeding motor 47 and a USB port 25 (as an example) for connecting to the personal computer 200 are respectively connected to the I/O interface 50. Further, the unit detection switches 58 for detecting the type of roll paper unit set and an error lamp 59 are connected through the I/O interface 50. A USB cable is connected to the USB port 25 and to the personal computer 200.

A print drive control program which reads out data from the print data memory area 561 (see FIG. 6) to drive the thermal head 13 and the tape feeding motor 47, a parameter table which specifies a duty ratio for determining the print energy for driving the thermal head 13 and the like are accommodated in the ROM 55. Print data and the like transmitted to and received from the personal computer 200 are accommodated in the RAM 56. A power portion 57 is connected to the respective drive circuits 42, 48, 49 and the control portion 40 to supply power.

Next, the memory area in the RAM 56 of the print apparatus 1 will be described with reference to FIG. 6. As shown in FIG. 6, the RAM 56 contains a print data memory area 561 for storing print data, a received medium information memory area 562 for storing medium information transmitted from the personal computer 200, a sensor value memory area 563 for storing the sensor value of the set roll paper unit 70, a medium information memory area 564 for storing the medium information of the roll paper unit 70, a program execution information memory area 565 for storing temporary data during an execution of the program and the like. Further, the RAM 56 includes other memory areas (not shown).

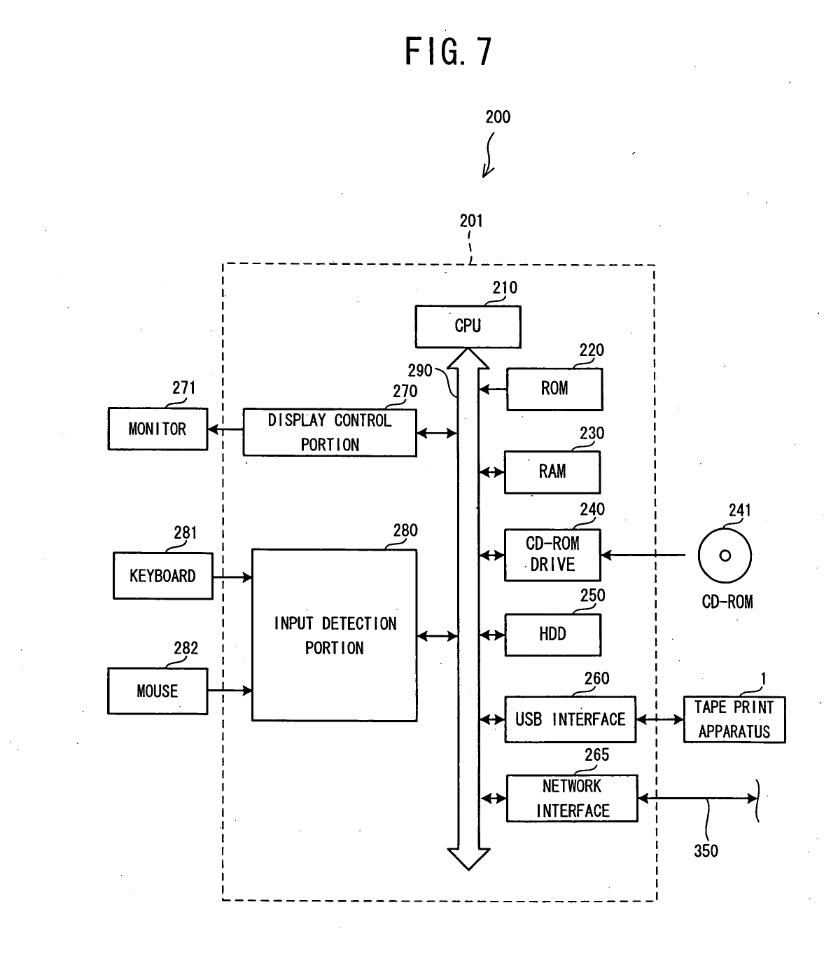

Next, the personal computer 200 will be described with reference to FIGS. 7 to 9. As shown in FIG. 7, the personal computer 200 includes a CPU 210 for controlling the personal computer 200. A ROM 220 which stores programs, such as BIOS, which the CPU 210 executes, a RAM 230 which temporarily stores data, a CD-ROM drive 240 in which a CD-ROM 241, as a data memory medium, is inserted to read out data and a HDD 250, which is a data memory unit, are connected to the CPU 210.

Further, a USB interface 260 for communicating with external units including the print apparatus 1, a display control portion 270 for carrying out the screen display processing of a monitor 271 for displaying an operation screen for a user, and a keyboard 281 and a mouse 282, which the user operates for input, are connected to the CPU 210 through the bus 290. Additionally, an input detection portion 280 for detecting the inputs of those components and a network interface 265 for connecting to the Internet 350 are connected thereto. Additionally, a floppy disc drive, audio input/output portions and various kinds of interfaces may be provided on the personal computer 200.

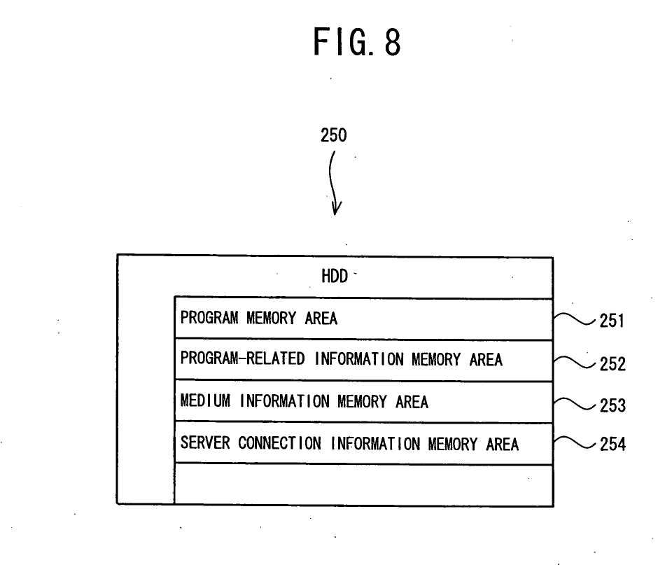

Print data creation program and setting and data to be used for executing the program are stored in the CD-ROM 241 and at the time of introduction into the personal computer 200, stored in a program memory area 251 (see FIG. 8) and program related information memory area 252 (see FIG. 8) provided in the HDD 250. The acquisition method of the print data creation program of the personal computer 200, data to be used thereby and the like is not restricted to the CD-ROM 241 or other recording medium, such as a floppy disc, DVD or MO, but it is permissible to connect the personal computer 200 to a local network and obtain from another terminal on the network or to download via the Internet.

Next, the memory area of the HDD 250 in the personal computer 200 will be described with reference to FIG. 8. As shown in FIG. 8, the HDD 250 includes a program memory area 251 which stores various kinds of programs, such as the print data creation program, to be carried out by the personal computer 200, a program-related information memory area 252 which stores information, such as setting, initial value and data necessary for executing the program, a medium information memory area 253 which stores medium information of the roll paper unit 70, a server connection information memory area 254 which stores information for connecting to the server 300 and the like. Further, the HDD 250 includes various kinds of memory areas (not shown).

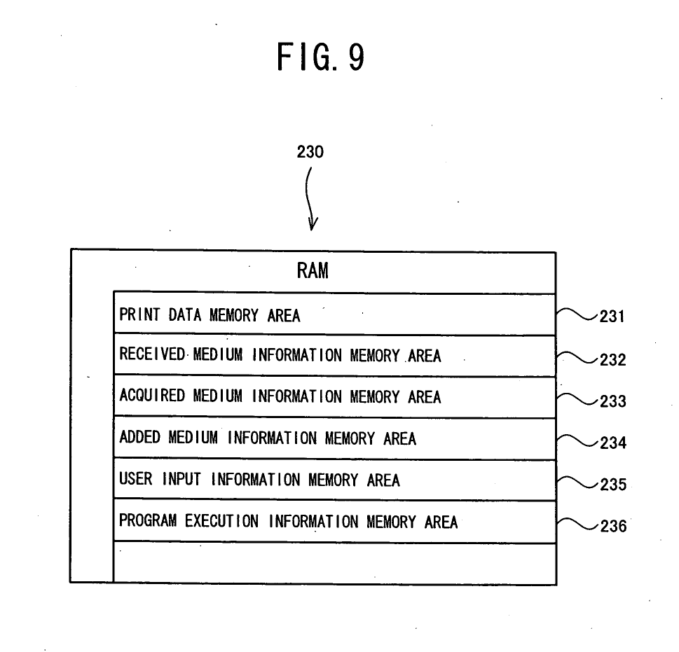

Next, the memory area of the RAM 230 in the personal computer 200 will be described with reference to FIG. 9. As shown in FIG. 9, the RAM 230 includes a print data memory area 231 which stores print data, a received medium information memory area 232 which stores received medium information transmitted by the print apparatus 1, an acquired medium information memory area 233 which stores medium information acquired from the server 300, an added medium information memory area 234 which stores medium information to be added to the print apparatus 1, a user input information memory area 235 which stores medium information inputted by a user, a program execution information memory area 236 which stores temporary data during an execution of the program and the like. Further, the RAM 230 includes other areas (not shown).

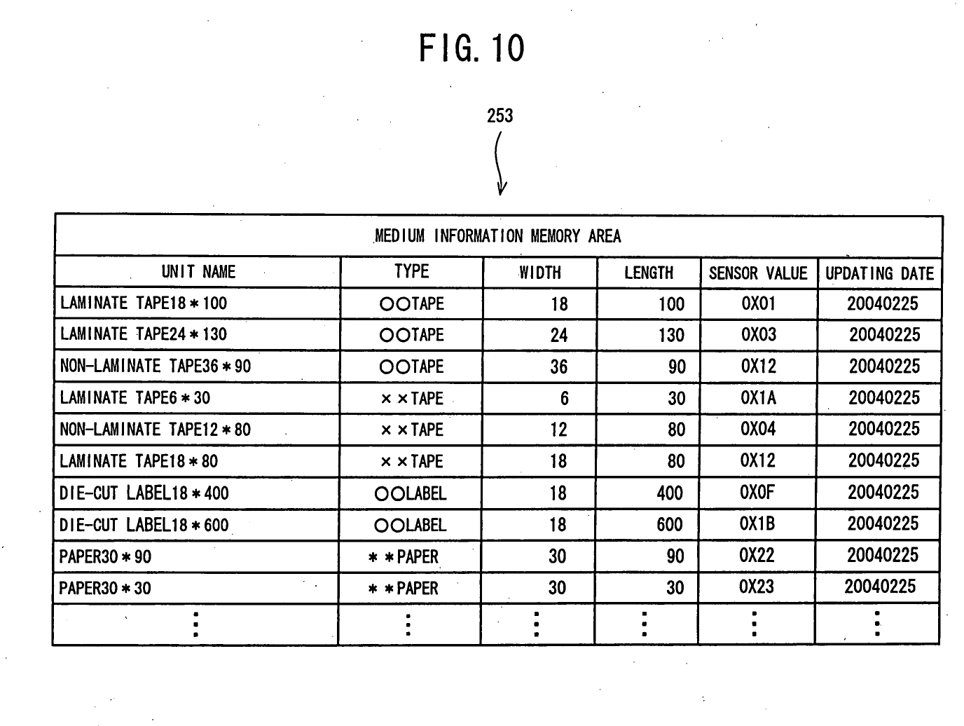

Here, the medium information memory area 253 in the HDD 250 of the personal computer 200 will be described. As shown in FIG. 10, the medium information memory area 253 of this embodiment includes a unit name column, a tape type column, a tape width column, a tape length column, a sensor value column, and an updating date column. The unit name column stores names of the roll paper units 70. The tape type column stores the types of tapes (types for specifying the shape and material of laminate tape, non-laminate tape, die-cut label, paper and the like). The tape width column stores the width of a tape loaded on the roll paper unit 70. The tape length column stores the cut length of a tape loaded on the roll paper unit 70. The sensor value column stores sensor values of each roll paper unit 70 to be detected by the unit detection switches 58 (hereinafter “unit detection switch 58” represents, in this exemplary embodiment, a unit of up to eight detection switches) in hexadecimal notation and the updating date column stores the date in which the medium information is stored.

In the example shown in FIG. 10, the tape type of a unit name “laminate tape 18*100” is a “OO tape”, the tape width is “18”, the tape length is “100”, the sensor value is “0×01” and the updating date is Feb. 25, 2004. Further, the tape type of a unit name “laminate tape 24*130” is a “OO tape”, the tape width is “24”, the tape length is “130”, the sensor value is “0×03” and the updating date is Feb. 25, 2004. The tape type of a unit name “non-laminate tape 36*90” is a “OO tape”, the tape width is “36”, the tape length is “90”, the sensor value is “0×12” and the updating date is Feb. 25, 2004. Further, the tape type of a unit name “laminate tape 6*30” is a “XX tape”, the tape width is “6”, the tape length is “30”, the sensor value is “0×1A” and the updating date is Feb. 25, 2004. The tape type of a unit name “non-laminate tape 12*80” is a “XX tape”, the tape width is “12”, the tape length is “80”, the sensor value is “0×04” and the updating date is Feb. 25, 2004. The tape type of a unit name “laminate 18*80” is a “XX tape”, the tape width is “18”, the tape length is “80”, the sensor value is “0×12” and the updating date is Feb. 25, 2004. The tape type of a unit name “die-cut label 18*400” is a “OO label”, the tape width is “18”, the tape length is “400”, the sensor value is “0×0F” and the updating date is Feb. 25, 2004. Further, the tape type of a unit name “die-cut label 18*600” is a “OO label”, the tape width is “18”, the tape length is “600”, the sensor value is “0×1B” and the updating date is Feb. 25, 2004. Further, the tape type of a unit name “paper 30*90” is a “** paper”, the tape width is “30”, the tape length is “90”, the sensor value is “0×22” and the updating date is Feb. 25, 2004. The tape type of a unit name “paper 30*30” is a “** paper”, the tape width is “30”, the tape length is “30”, the sensor value is “0×23” and the updating date is Feb. 25, 2004. The symbols “OO”, “XX”, and “**” represent a name for the tape.

Further, information handled as medium information is not restricted to that described. Needless to say, it may include information about print energy of a heat generating element in the thermal head 13 and other information, such as an updating time. The medium information memory area 564 of the print apparatus 1 and the added medium information memory area 234 of the personal computer have the same configuration as the medium information memory area 253 of the personal computer 200.

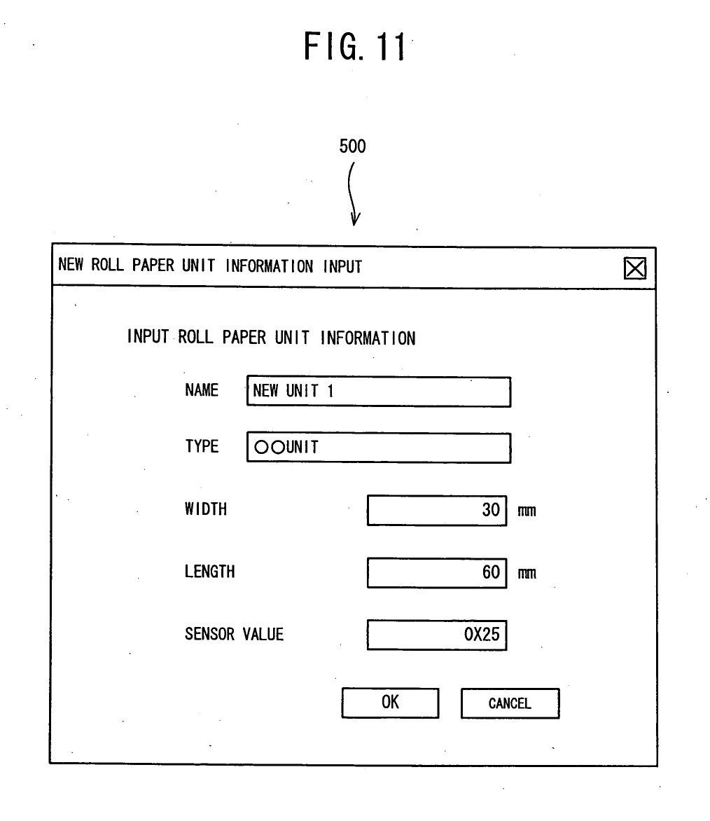

Next, the new roll paper unit information input screen 500, which is displayed on the monitor 271 of the personal computer 200 and in which an operator inputs medium information, will be described. As shown in FIG. 11, the new roll paper unit information input screen 500 contains a message saying “input roll paper unit information”, a name input row, a type input row, a tape width input row, a tape length input row, a sensor value input row, an OK button and a Cancel button. The values to be inputted to these input rows are those described on a sales package of the roll paper unit 70, its operation manual or published on a home page of sales company of the roll paper unit 70. After input, the data are stored in the medium information memory area 253 in the form shown in FIG. 10. In the example shown in FIG. 11, “new unit 1” is inputted in the name input space, “such a unit” is inputted in the type input space, “30” is inputted in the tape width space, “60” is inputted in the tape length input space and “0×25” is inputted in the sensor value input space.

In the print apparatus 1 according to the first embodiment, medium information concerning the roll paper unit 70 about a tape width, tape length and the like is stored in the medium information memory area 564 of the RAM 56 and the medium information is read out from the medium information memory area 564 based on the sensor value in order to identify the roll paper unit 70, which is determined on the basis of a detection result of the unit detection switch 58, so that a print start position and print energy required for the heat generating elements of the thermal head 13 are determined. The medium information is provided by a manufacturer of the print apparatus 1 upon manufacturing and stored in the print apparatus 1. Thus, if it is intended to print on the tape 71 of a roll paper unit 70 whose medium information is not registered in the medium information memory area 564, normal printing is disabled. Then, if it is determined that a new roll paper unit 70 is set according to a detection signal of the unit detection switch 58, it is necessary to obtain information for that roll paper unit 70.

Then, in the print apparatus 1 of the first embodiment, when a new roll paper unit 70 is detected, shortage request information is sent to the personal computer 200 requesting the personal computer 200 to transmit the medium information (short medium information) of the new roll paper unit 70. If the personal computer 200 stores the requested medium information (short medium information) in the medium information memory area 253, the medium information is sent to the print apparatus 1. If there is no short medium information, the personal computer 200 is connected to the server 300 so as to acquire all updated medium information provided by the server 300 and if a desired short medium information exists through the server 300, it is sent to the print apparatus 1. If the personal computer 200 cannot be connected to the server 300 or no short medium information exists in the all updated medium information (acquired medium information) acquired from the server 300, the operator is urged to input the medium information.

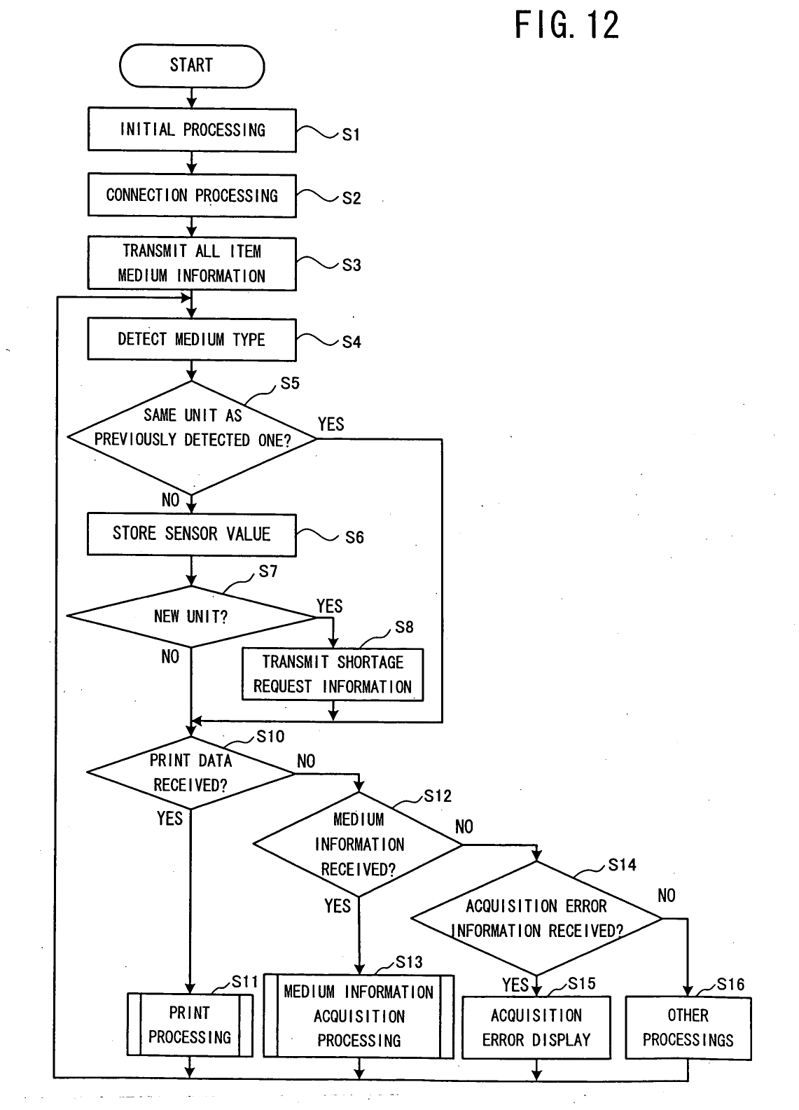

Processing done in the print apparatus 1 will be explained with reference to flowchart in FIGS. 12 to 14. The main processing shown in FIG. 12 is started if the print apparatus 1 is powered on. Then, initial processing, such as initialization of data area in the RAM 56 and verification of the operation of the print mechanism 20, is carried out (S1). A connection processing for connecting to the personal computer 200 is then carried out (S2). If connection to the personal computer 200 is attained, all medium information pieces stored in the medium information memory area 564 are sent to the personal computer 200 (S3). Then, a signal from the unit detection switch 58 is detected (S4). Whether a new or different roll paper unit 70 is mounted is determined depending on whether the sensor value of the roll paper unit 70 indicated by the detected signal is equal to the previous detected sensor value stored in the sensor value memory area 563 (S5). Here, because the value of the sensor value memory area 563 is also initialized in S1 when the print apparatus 1 is started up, it is not determined that it is equal (there being no value to compare with) (S5: NO) and a detected sensor value is stored in the sensor value memory area 563 (S6). Then, whether the roll paper unit 70 is a new medium is determined (S7). The detected sensor value is compared with the sensor values stored in the sensor value column of the medium information memory area 564 to determine whether any medium information is registered for the detected sensor value. If it is registered, the procedure proceeds to S10 without any treatment because the roll paper unit 70 is not a new medium (S7: NO).

If the detected sensor value is not stored in the sensor value column of the medium information memory area 564, it is determined that it is a new roll paper unit 70 (S7: YES) and a shortage request information is transmitted to the personal computer 200 (S8). If no roll paper unit 70 is set when the print apparatus 1 is started, no unit detection switch 58 is pressed and therefore the same value as an initialization value “0000” of the sensor value memory area 563 is adopted. Then, in this case, it is judged to be equal to a sensor value stored in the sensor value memory area 563 (S5: YES) and the procedure proceeds to S10 without any treatment.

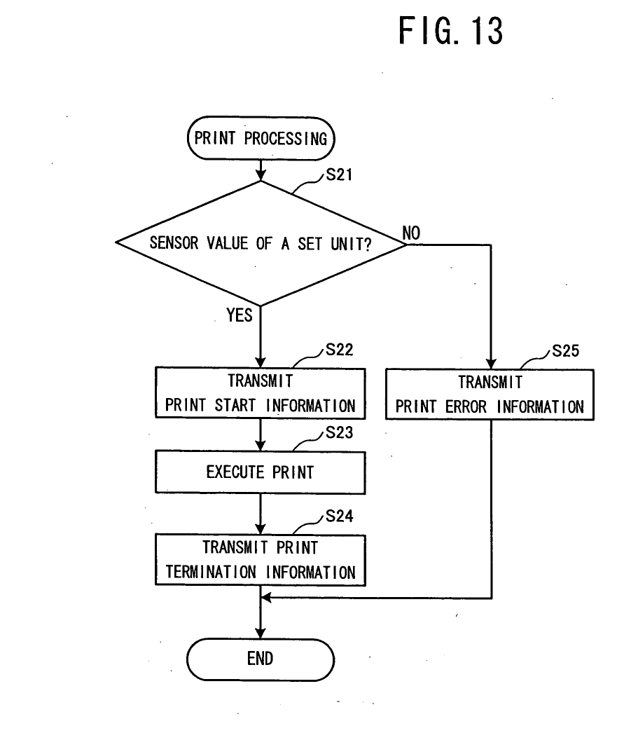

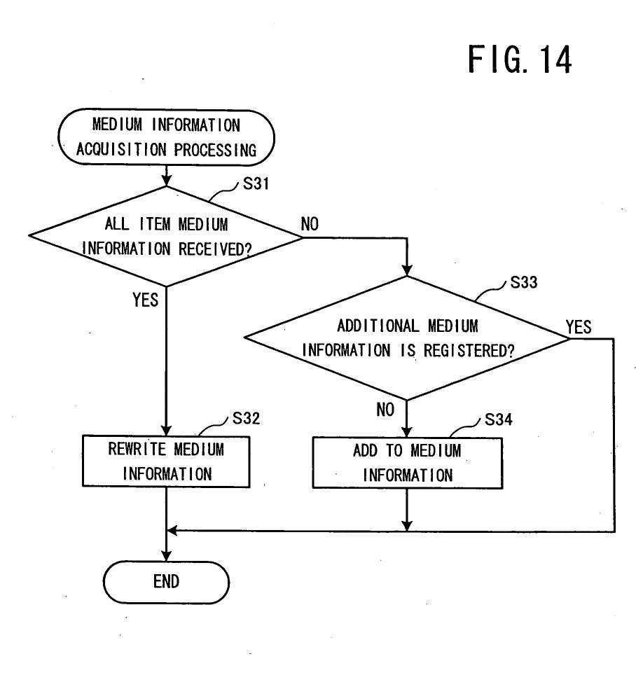

Whether any print data is received from the personal computer 200 is determined (S10) and if print data is received (S10: YES), print processing is carried out (S11: see FIG. 13). If no print data is received (S10: NO), whether any medium information is received from the personal computer 200 is determined (S12). If the medium information is received (S12: YES), medium information acquisition processing is carried out (S13: see FIG. 14). If no medium information is received (S12: NO), whether any acquisition error information is received from the personal computer 200 is determined (S14). If the acquisition error information is received (S14: YES), an error lamp 59 is lit to notify the user that the requested medium information cannot be acquired from the personal computer 200 as the acquisition error is indicated (S15). If no acquisition error information is received (S14: NO), other processing is carried out (S16), such as processing to acquire the status of the print apparatus 1.

Then, the procedure returns to S4, in which a signal from the unit detection switch 58 is detected (S4). If a sensor value of the roll paper unit 70 indicated by the detected signal is equal to the previous detected sensor value stored in the sensor value memory area 563 (S5: YES), the procedure proceeds to S10 without other intervening actions, because a judgment on whether the new roll paper unit 70 has been already set and its corresponding treatment (S6 to S8) are carried out. Then, processings for reception of data from the personal computer 200 (S10 to S15) and other processing (S16) are carried out. Then, the processing returns to S4, in which the processing (S4 to S16) is repeated.

The print processing (S10: YES, S11) for printing print data transmitted from the personal computer 200 will be described with reference to the flowchart of FIG. 13. First, whether the sensor value of the roll paper unit 70 specified according to a received print data is the sensor value of the set roll paper unit 70 is determined (S21). If the sensor value contained in the print data is the sensor value stored in the sensor value memory area 563 (S21: YES), normal printing can be carried out. Therefore, print start information is transmitted to the personal computer 200 (S22) and the print is executed (S23). If, or when, the print is terminated, print termination information is transmitted to the personal computer 200 (S24) and the print processing ends. The print start information and print termination information are for controlling the display of the “print execution screen” in the personal computer 200.

Because the normal print is enabled only when the sensor value of the roll paper unit 70 specified by the received print data is the sensor value of the set roll paper unit 70 (S21: NO), the print error information is transmitted to the personal computer 200 (S25) and the print processing is terminated without executing the print when the two sensor values do not agree.

Here, the medium information acquisition processing (S12: YES, S13) to be carried out when the medium information is received from the personal computer 200 will be described with reference to the flowchart of FIG. 14. As for the medium information transmitted from the personal computer 200, in some cases, all pieces of the medium information stored in the medium information memory area 253 of the personal computer 200 are transmitted or, in some cases, only a single piece of the medium information is transmitted.

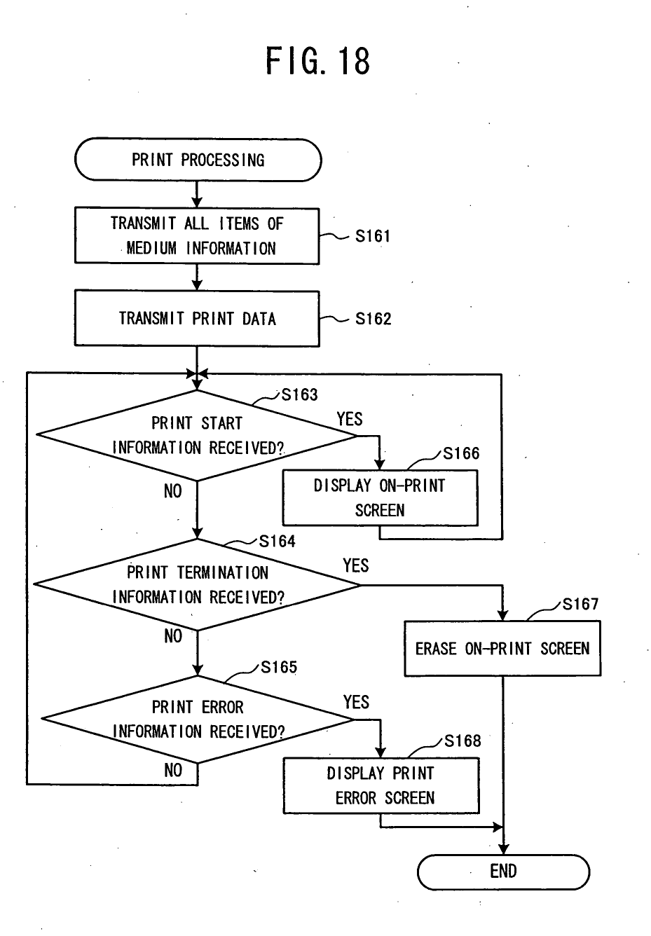

The former is transmitted before the personal computer 200 transmits print data (see S161 in FIG. 18 directed to processing in the personal computer). This corresponds to a case where no medium information can be acquired when the new roll paper unit 70 is set up. The case where no medium information can be acquired refers to a case where in the personal computer 200, there is no medium information stored in the medium information memory area 253 when the shortage request information is received so that it cannot be connected to the server 300 and no input by an operator occurs. For example, the connection to the server 300 cannot be made if the personal computer 200 is not in an environment for connecting to the Internet 350 or the server 300 is down or under maintenance. As the case where no input by the operator occurs, it is possible to consider a case where the operator does not know a value which he/she should input at that time or he/she cancels the input by mistake. If the medium information is acquired by connecting to the server 300 after that or the input by the user occurs, then the medium information is possessed at the time of printing although the personal computer 200 cannot acquire any medium information when the new roll paper unit 70 is detected. Then, when the print data is transmitted, all pieces of the medium information stored in the medium information memory area 253 are transmitted to the print apparatus 1.

The latter case refers to a case where the short medium information requested by the print apparatus 1 from the personal computer 200 is transmitted or a case where, when all pieces of medium information stored in the medium information memory area 564 are transmitted at the time of startup of the print apparatus 1 (see S3 in FIG. 12), there exists some medium information, which is not stored in the all pieces of the medium information although stored in the medium information memory area 253 of the personal computer 200, and that medium information is transmitted to be added to the print apparatus 1.

Thus, in the medium information acquisition processing S13, whether the received medium information is the medium information of all pieces is determined (S31). If it is the medium information of all pieces (S31: YES), the medium information stored in the medium information memory area 564 is rewritten to the medium information of all pieces received (overwritten) (S32). When the medium information of all pieces is not received (S31: NO), but rather it is medium information of a single piece, whether that information is registered in the medium information memory area 564 is confirmed (S33). If the medium information of a single piece is already registered (S33: YES), nothing is done. If it is not registered (S33: NO), the received medium information of a single piece is added to and stored in the medium information memory area 564 (S34). Further, the content of the registration is compared and if the content is different even though the sensor value is stored, the content is rewritten to the received information. Then, the medium information acquisition processing is ended.

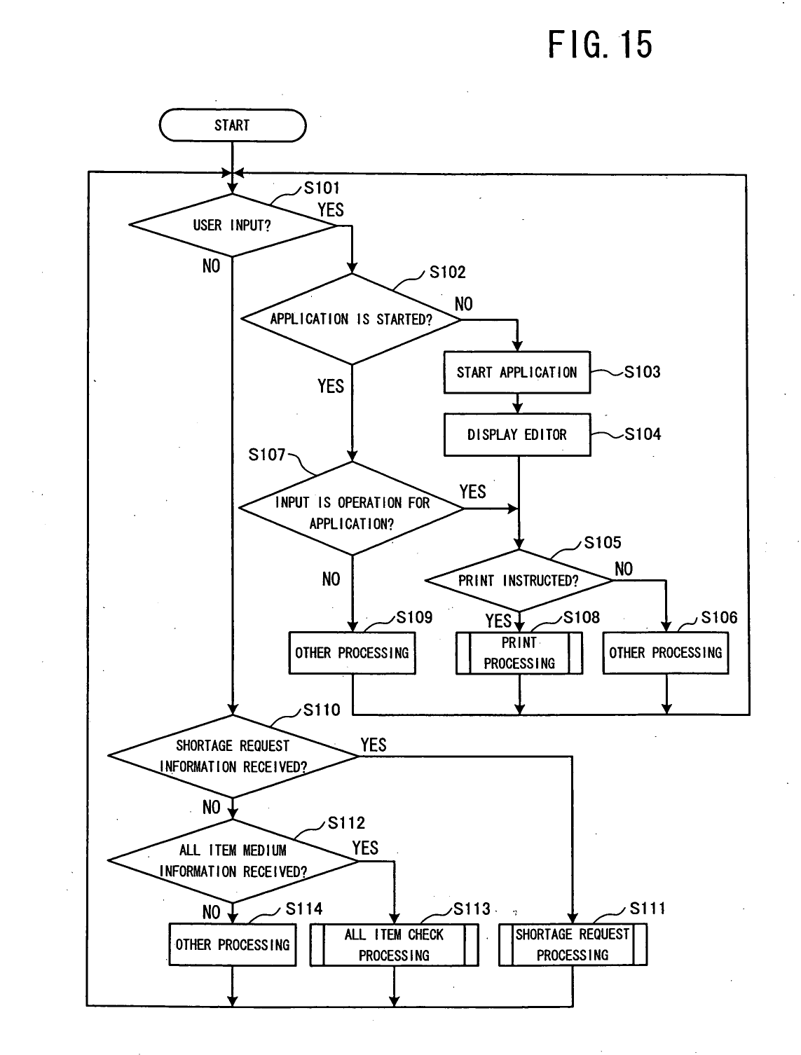

Next, the processing of the personal computer 200 will be described with reference to the flowcharts of FIGS. 15 to 18. The main processing shown in FIG. 15 is started when the print apparatus 1 is connected. Then, whether any user input using the keyboard 281 or the mouse 282 is carried out is determined (S101). If the user input is not carried out (S101: NO), whether a shortage request information is received from the print apparatus 1 is determined (S110). If no shortage request information is received (S110: NO), whether the medium information of all pieces is received is determined (S112). When the medium information of all pieces is not received (S112: NO), other processing in the operating system is carried out (S114) and the procedure returns to S101. Then, the processings of S101, S110, S112, S114 are repeated until receipt of a user input, or receipt of a shortage request information or medium information of all pieces is received (S101: YES, S110: YES, S112: YES).

If there is a user input (S101: YES), whether an application for editing print data to be printed by the print apparatus 1 is active is determined (S102). If the application is not active (S102: NO), the application is started (S103) and an editor (not shown), which is a screen for editing the print data, is displayed on the monitor 271 (S104). Then, the process proceeds to S105 and because no print instruction is dispatched (S105: NO), other inherent application processing is carried out (S106) and the procedure returns to S101.

After the user input is accepted (S101: YES), during the repetitive processing of S101, S110, S112, S114, whether the input is an operation for this application is determined (S107: NO) because the application is already started (S102: YES). If it is not an operation for this application (S107: NO), other processing corresponding to the operation is carried out (S109) and the procedure returns to S101. If it is a processing for this application (S107: YES), whether that operation is a print instruction is determined (S105). Then, if it is a print instruction (S105: YES), print processing of transmitting print data to the print apparatus 1 and executing the print is carried out (S108, see FIG. 18). Then, the procedure returns to S101. When a print instruction is not dispatched (S105: NO), a processing for the instruction is carried out (S106) and the procedure returns to S101.

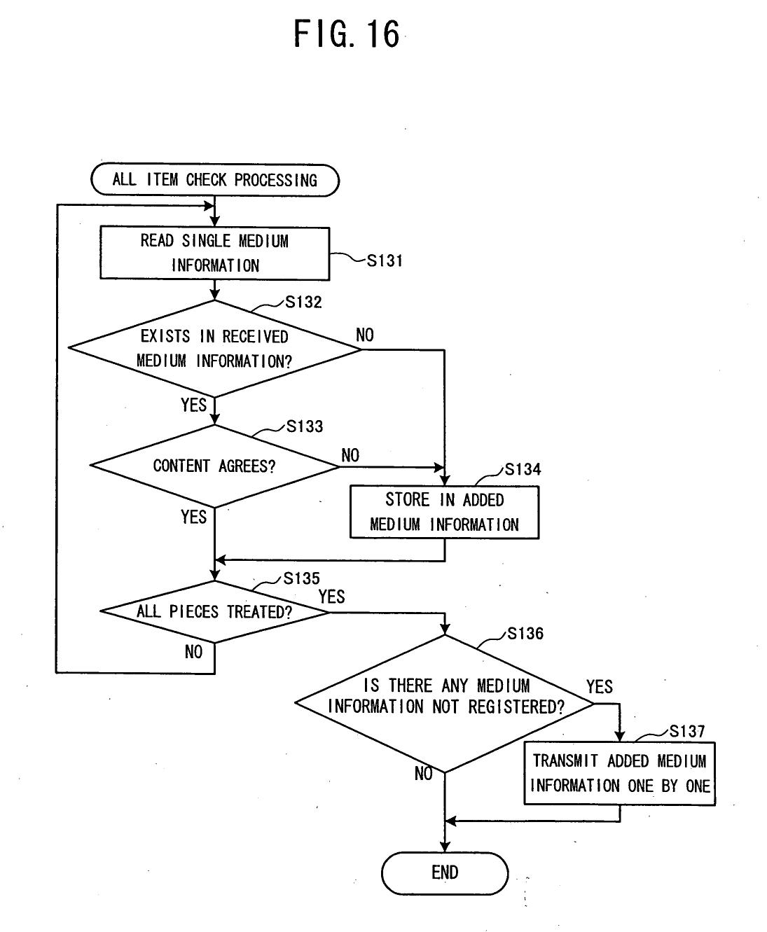

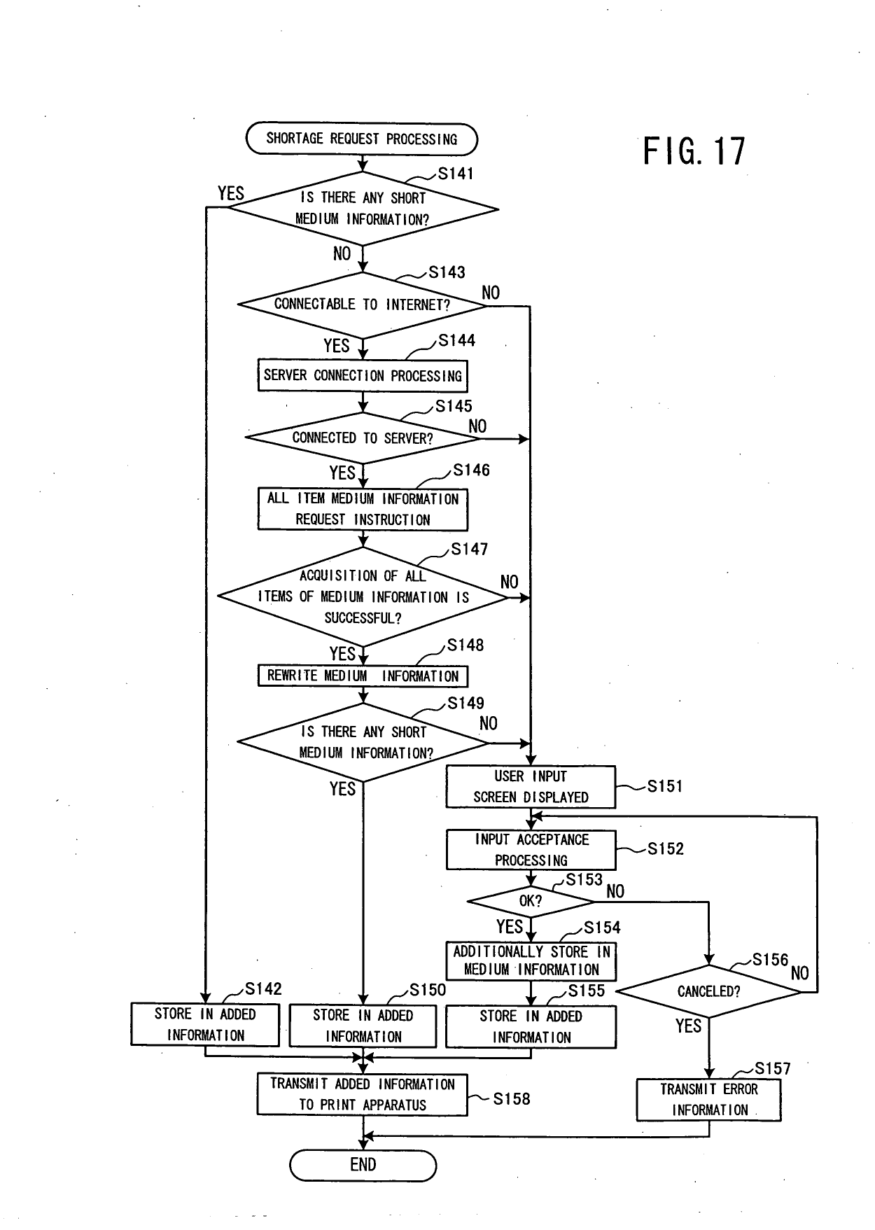

If the shortage request information is received (S101: NO, S110: YES), shortage request processing for transmitting the medium information requested by the print apparatus 1 to the print apparatus 1 is carried out (S111, FIG. 17) and the procedure returns to S101. If the medium information of all pieces is received (S101: NO, S110: NO, S112: YES), all piece check processing for transmitting the medium information, which is not contained in the received all piece medium information but stored in the medium information memory area 253, to the print apparatus 1 is carried out (S113, FIG. 16). Then, the procedure returns to S101 and in this main processing, the process is repeated.

Here, the all piece check processing will be described with reference to FIG. 16. The print apparatus 1 transmits the all piece medium information stored in the medium information memory area 564 at the startup time (see S3 in FIG. 12). In order to add the medium information which is not contained in the all piece medium information transmitted but contained in the medium information memory area 253 of the personal computer 200 to the medium information memory area 564 of the print apparatus 1, the received all piece medium information is compared with the medium information stored in the medium information memory area 253 of the personal computer 200.

A single piece of the medium information stored in the medium information memory area 253 is read out (S131). Whether medium information of a sensor value of the thus read out medium information (read-out medium information) exists in a received medium information (received medium information stored in the received medium information memory area 232) is determined (S132) and if there is no such information (S132: NO), read-out medium information is stored in the added medium information memory area 234 (S134). If the medium's information exists in the received medium information (S132: YES), whether the content of each item of the medium information matches is determined (S133). If it does not match (S133: NO), the read-out medium information is stored in the added medium information memory area 234 (S134), because it means that the medium information of that sensor value has been changed. If the content matches (S133: YES), that medium information does not need to be transmitted to the print apparatus 1 and therefore nothing is done.

Whether processing of all medium information in the medium information memory area 564 has been completed is determined (S135) and if the processing of all medium information is not completed (S135: NO), the procedure returns to S131, in which a next piece of the medium information is read out (S131) and compared to the received medium information (S132 to S134). The processings of S131 to S134 are repeated until the processing of all medium information is completed (S135: YES). With added medium information added to the added medium information memory area 234, whether there is any medium information not registered is determined (S136). If there is any medium information not registered (S136: YES), the medium information is transmitted to the print apparatus 1 piece by piece (S137). When the transmission of all the added medium information pieces is completed, the all item, or piece, check processing is terminated. If there is no medium information not registered (S136: NO), the all piece check processing is terminated without executing anything.

Next, the shortage request processing will be described with reference to FIG. 17. When it is detected that a new roll paper unit 70 is set, the print apparatus 1 requests the personal computer 200 to send the medium information of that roll paper unit 70 (see S8 in FIG. 12). Then, the short medium information is sent to the print apparatus 1. If it cannot be transmitted, acquisition error information is transmitted.

First, whether the short medium information is stored in the medium information memory area 253 of the personal computer 200 is determined (S141). If the short medium information is stored in the medium information memory area 253 (S141: YES), that information is transmitted to the print apparatus 1. Therefore, the medium information is stored in the added medium information memory area 234 (S142) and the medium information stored in the added medium information memory area 234 is transmitted to the print apparatus 1 (S158). Then, the shortage request processing is terminated.

If the short medium information is not stored in the medium information memory area 253 (S141: NO), it is necessary to acquire the short medium information from the server 300. Then, whether setting allowing connection to the Internet 350 is made is determined (S143) and if such setting is made (S143: YES), connection processing to the server 300 is carried out according to information stored in the server connection information memory area 254 (S144). If the connection to the server 300 is made (S145: YES), a signal for requesting all medium information pieces is transmitted to the server 300 (S146). If the medium information is acquired from the server 300 (S147: YES), a set of existing acquisition medium information is rewritten (overwritten) into the medium information memory area 253 (S148) as the medium information memory area 253 has, in this exemplary embodiment, information for a predetermined number of the medium. Then, whether there is any short medium information in the medium information memory area 253 is determined (S149) and if there is any short medium information (S149: YES), it means that the short medium information has been acquired and therefore it is stored in the added medium information memory area 234 (S150). The medium information is then transmitted to the print apparatus 1 (S158) and the shortage request processing is terminated.

If the setting allowing connection to the Internet 350 is not made (S143: NO), the connection to the server 300 fails (S145: NO), no medium information can be acquired from the server 300 (S147: NO) or no short medium information is contained in the acquired medium information (S149: NO). It means that no short medium information is stored in the medium information memory area 253 and thus, user input processing which urges an operator to input each item of the medium information is carried out (S151 to S157).

In such a case, the new roll paper unit information input screen 500 is displayed on the monitor 271 (S151). Then, input acceptance processing for an input item of the new roll paper unit information input screen 500 is carried out (S152) and before an OK button or a Cancel button is selected (S153: NO, S156: NO), the procedure returns to S152, in which the repetitive input acceptance processing and the acceptance processing of the OK button and Cancel button (S152, S153, S156) are carried out. If the OK button is not selected (S153: NO) and the Cancel button is selected (S156: YES), acquisition error information is transmitted to the print apparatus 1 (S157) and the shortage request processing is terminated.

If the OK button is selected (S153: YES) and the medium information is stored in the medium information memory area 253 (S154), that medium information is then stored in the added medium information memory area 234 (S155) and the medium information stored in the added medium information memory area 234 is transmitted to the print apparatus 1 (S158). Then, the shortage request processing is terminated.

Next, the print processing will be described with reference to FIG. 18. Here, first, all pieces of the medium information stored in the medium information memory area 253 of the personal computer 200 are transmitted to the print apparatus 1 (S161) and then the print data is transmitted (S162). Next, if print start information is received from the print apparatus 1 (S163: YES), an on-print screen (not shown) indicating that the print apparatus 1 is printing is displayed on the monitor 271 (S166) and the procedure returns to S163. If print termination information is received (S163: NO, S164: YES), the on-print screen is erased (S167) and the print processing is terminated. If print error information is received (S163: NO, S164: NO, S165: YES), a print error screen indicating that print was not carried out properly is displayed on the monitor 271 (S168). Then, the print processing is terminated. Before the print termination information or the print error information is received (S164: NO, S165: NO), the processings in S163 to S164 are repeated so as to wait for reception of the print termination information or the print error information.

According to the first embodiment, medium information of the new roll paper unit 70 can be obtained by the print apparatus 1 in the above-described manner.

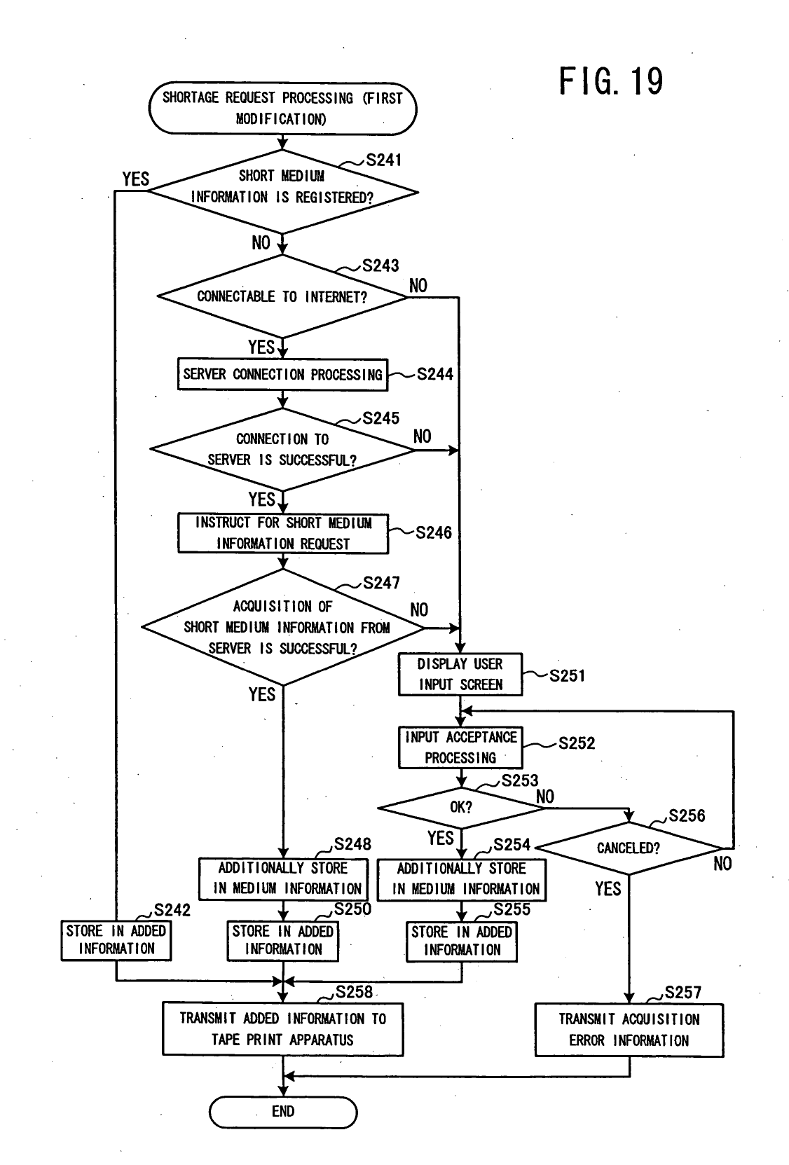

The first embodiment is not restricted to the above-described processings and may be modified in various ways. A first modification of the first embodiment will be described with reference to the flowchart of FIG. 19. Although according to the first embodiment, when the personal computer 200 receives any shortage request information from the print apparatus 1, if the short medium information is not stored in the medium information memory area 253 of the personal computer 200, the personal computer 200 is connected to the server 300 to acquire all pieces of the medium information from the server 300, according to the first modification, only the short medium information is acquired from the server 300. The processings of S146 to S150 in the flowchart of the shortage request processing of the first embodiment turn to processings of S246 to S250 of the first modification shown in FIG. 19. The other steps (S241 to S245, S251 to S258) of the first modification shown in FIG. 19 are equal to those of S141 to S145, S151 to S158 of the shortage request processing of the first embodiment shown in FIG. 17. Therefore, description of the equivalent steps is omitted by referring to those descriptions.

If the connection to the server 300 is made (S243: YES, S244, S245: YES) before the short medium information is stored in the medium information memory area 253 as shown in FIG. 19, a signal requesting short medium information is transmitted to the server 300 (S246). If the short medium information is acquired from the server 300 (S247: YES), that medium information is added to and stored in the medium information memory area 253 (S248). Then, it is stored in the added medium information memory area 234 (S250) and transmitted to the print apparatus 1 (S258). Then, the shortage request processing is terminated.

A second modification of the first embodiment will be described next. Although according to the second modification of the first embodiment, when the personal computer 200 receives short medium information from the print apparatus 1, medium information stored in the medium information memory area 253, medium information acquired from the server 300 or medium information inputted by user are returned to the print apparatus 1, according to this second modification, when short medium information is received, all pieces of the medium information including a requested short medium information is sent to the print apparatus 1.

That is, in S158 of the first embodiment of the shortage request processing, shown in FIG. 17, the medium information stored in the added medium information memory area 234 is not transmitted, rather all pieces of the medium information stored in the medium information memory area 253 are transmitted to the print apparatus 1. As a result, because, according to the second modification, the medium information does not need to be stored in the added medium information memory area 234, the processings of S142, S150, and S155 are not carried out. In a similar manner, in S258 of the shortage request processing shown in FIG. 19, the medium information stored in the added medium information memory area 234 is not transmitted, rather all pieces of the medium information stored in the medium information memory area 253 are transmitted. Because, according to the second modification, the medium information does not need to be stored in the added medium information memory area 234, the processings of S242, S250, and S255 are not carried out.

Next, a third modification of the first embodiment will be described. Although according to the first embodiment and its modification, if no short medium information is stored in the medium information memory area 253, the medium information is acquired from the server 300, according to the third modification, there is no configuration for connecting to the server 300. Thus, if the information is not stored in the medium information memory area 253, correspondence is made only by input from the user. Therefore, in the shortage request processing shown in FIG. 17, if the information is not stored in the medium information memory area 253 (S141: NO), the procedure proceeds to S151, in which the user input processing is carried out (S151 to S157). Meanwhile, the processings of S143 to S150 are not carried out. In the shortage request processing shown in FIG. 19, if the information is not stored in the medium information memory area 253 (S241: NO), the procedure proceeds to S251, in which the user input processing is carried out (S251 to S257). Meanwhile, the processings of S243 to S250 are not carried out.

Next, a fourth modification of the first embodiment will be described. According to the first embodiment and its modifications, when the print apparatus 1 is started up, all pieces of the medium information are transmitted to the personal computer 200 (see S3 in FIG. 12) and stored in the medium information memory area 253 of the personal computer 200 and the medium information missing in the all piece medium information received from the print apparatus 1 is transmitted to the print apparatus 1 as the added medium information (see FIG. 16) and stored in the medium information memory area 564 (see S34 in FIG. 14). According to the fourth modification, if that information is stored in the medium information memory area 253 in the personal computer 200 and does not exist in the all piece medium information received from the print apparatus 1, the all piece medium information stored in the medium information memory area 253 are transmitted to the print apparatus 1. That is, in the all piece check processing of the personal computer 200 shown in FIG. 16, if there is any medium information not registered (S136: YES), the all pieces of the medium information stored in the medium information memory area 253 are transmitted to the print apparatus 1 in S137. In S134, it is permissible to provide a not-registered medium information counter instead of storing the medium information in the added medium information memory area 234 and count up the number of not registered medium information pieces.

Next, a fifth modification of the first embodiment will be described. When the print apparatus 1 is started up, all pieces of the medium information are transmitted to the personal computer 200 (see S3 in FIG. 12) and stored in the medium information memory area 253 of the personal computer 200. Any medium information not existing in the all piece medium information received from the print apparatus 1 is transmitted to the print apparatus 1 as added medium information (see FIG. 16) and is added to and stored in the medium information memory area 564 (see S34 of FIG. 14). According to the fifth modification, the all pieces of the medium information are not transmitted from the print apparatus 1 to the personal computer 200. When the personal computer 200 is connected to the print apparatus 1, the personal computer 200 transmits all the medium information pieces stored in the medium information memory area 253.

That is, in the main processing of the print apparatus 1 shown in FIG. 12, the processing for (S3) transmitting all pieces of the medium information to the personal computer 200 is not carried out. Then, in the main processing of the personal computer 200 shown in FIG. 15, when an application is started up (S101: YES, S102: NO), the all pieces of the medium information in the medium information memory area 253 are transmitted to the print apparatus 1. This processing may be executed after the application is started up (S103) or after the display processing of an editor (S104) is performed. Then, in the main processing of the print apparatus 1, it is determined that the medium information has been received (FIG. 12, S12: YES) and it is determined that all the pieces of the medium information have been received in the medium information acquisition processing (FIG. 14, S31: YES) and all the medium information stored in the medium information memory area 564 are rewritten to the all piece medium information received (S32).

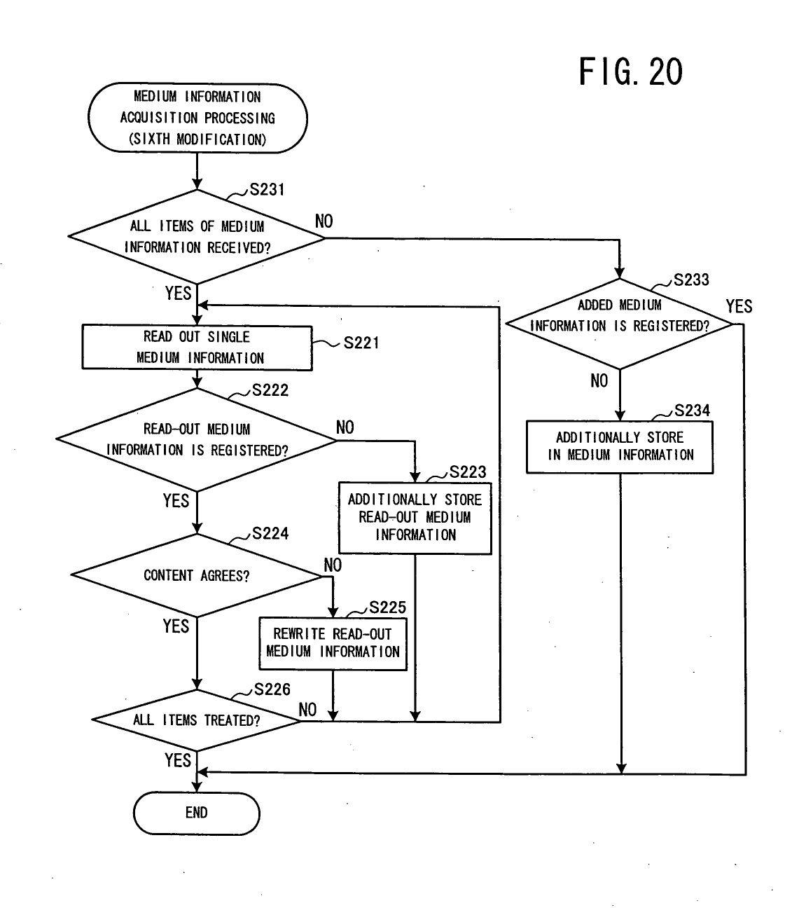

Next, a sixth modification of the first embodiment will be described with reference to a flowchart of FIG. 20. Although according to the first embodiment and its modification, when the print apparatus 1 receives all pieces of the medium information from the personal computer 200, the received medium information is overwritten in the medium information memory area 564, according to the sixth modification, the received medium information is compared with the medium information stored in the medium information memory area 564 and only medium information not stored in the medium information memory area 564 and medium information whose content is different (changed medium information) are added and stored or rewritten. Then, the processing of S32 in the flowchart of the medium information acquisition processing of the first embodiment shown in FIG. 14 turns to the processings of S221 to S226 shown in FIG. 20. Meanwhile because the other steps (S231; NO, S233, S234) of the sixth modification shown in FIG. 20 are equal to S31: NO, S33, S34 in the medium information acquisition processing of the first embodiment shown in FIG. 14, a description thereof is omitted by referring to the earlier description for those steps.

If all the pieces of the medium information are received (S231: YES) as shown in FIG. 20, a single piece of the medium information is read out from the received medium information (S221). Then, whether the read out medium information is stored in the medium information memory area 564 is determined (S222). If the single piece is not registered (S222: NO), it is additionally stored in the medium information memory area 564 (S223). If the single piece is registered (S222: YES), whether the content of each item corresponds is determined (S224). If it does not correspond (S224: NO), the content of the medium information memory area 564 is rewritten (overwritten) to the content of the received medium information, because there occurs a change in the single piece of the medium information (S225). If the content corresponds (S224: YES), it is not necessary to store the medium information and, thus, nothing is done.

Then, whether the processing of all medium information pieces in the medium information memory area 564 is carried out is determined (S226) and if the processing of all the medium information is not completed (S226: NO), the procedure returns to S221, in which a next medium information piece is read out (S221) and comparison processing with the medium information memory area 564 is carried out (S223 to S225). Then, the processings of S221 to S226 are repeated and if the processing of all the medium information pieces is completed (S226: YES), the medium information acquisition processing is terminated.

Next, a seventh modification of the first embodiment will be described. Although according to the seventh modification, the print apparatus 1 is connected to the personal computer 200, the personal computer 200 does not always need to be connected to the server 300. According to the first embodiment and its modifications, when a new roll paper unit 70 is detected in the print apparatus 1, short medium information requesting for the medium information of that roll paper unit 70 is transmitted to the personal computer 200. According to the seventh modification, an all piece request information which requests all pieces of the medium information stored in the personal computer 200 is transmitted to the personal computer 200 instead of requesting only the medium information about the new roll paper unit 70.

That is, if in the main processing shown in FIG. 12 of the print apparatus 1, a detected sensor value is not stored in the sensor value column of the medium information memory area 564 and the roll paper unit 70 is determined to be a new roll paper unit 70 (S7: YES), not a shortage request information but an all piece request information is transmitted to the personal computer 200 in S8. In S110 of the main processing shown in FIG. 15 of the personal computer 200, rather than whether a shortage request information, an all piece request information is received is determined. If the all piece request information is received (S110: YES), the shortage request processing (see FIG. 17) is not executed, but all pieces of the medium information stored in the medium information memory area 253 are transmitted to the print apparatus 1.

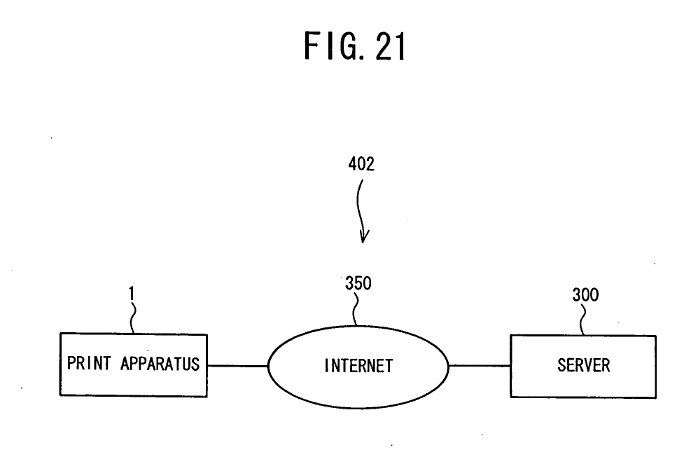

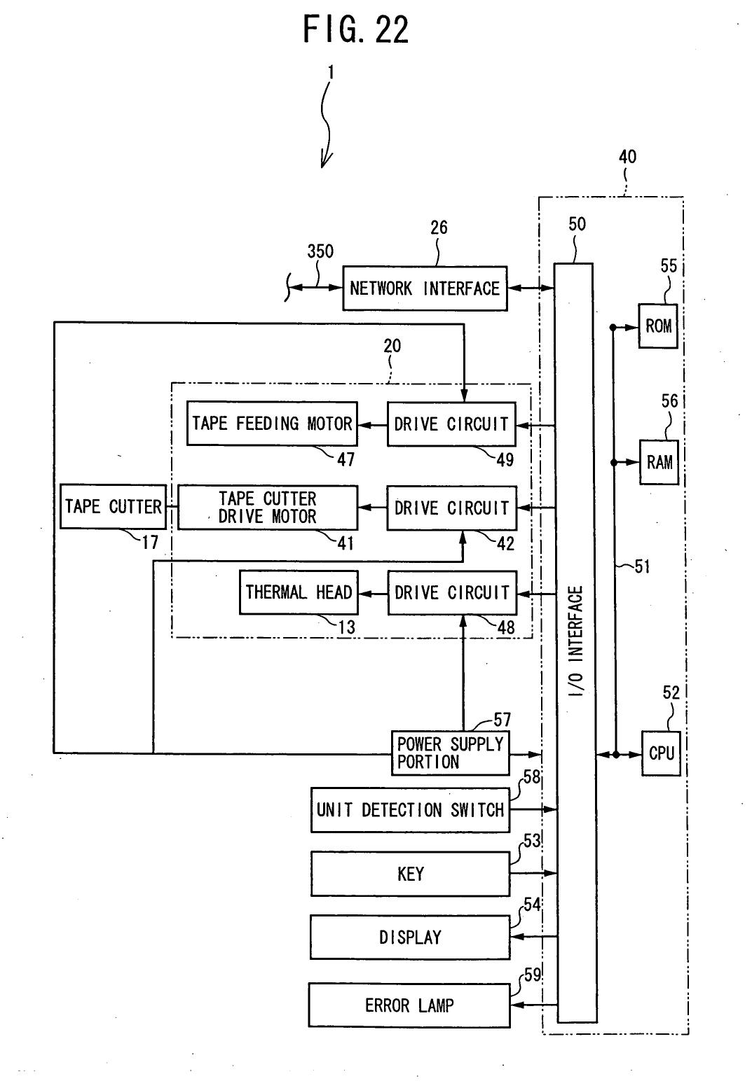

Next, the second embodiment will be described with reference to FIGS. 21 to 24. According to the second embodiment, as shown in FIG. 21, the print apparatus 1 is connected to the server 300 through the Internet 350. According to the second embodiment, editing print content is performed in the print apparatus 1. As indicated in the block diagram of FIG. 22, the print apparatus 1 of the second embodiment is provided with keys 53 and a display 54 in addition to what is found in the print apparatus 1 of the first embodiment, shown in FIG. 5. The keys 53 and the display 54 are connected to the I/O interface 50. Further, the network interface 26 for connecting to the Internet 350 is connected to the I/O interface 50. Meanwhile, connection information for connecting to the server 300 is stored in the ROM 55.

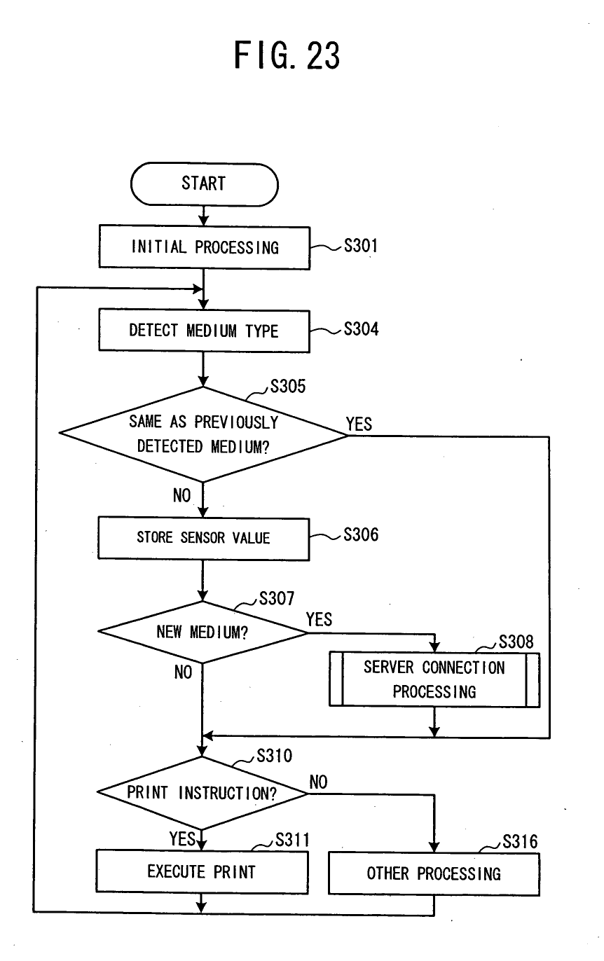

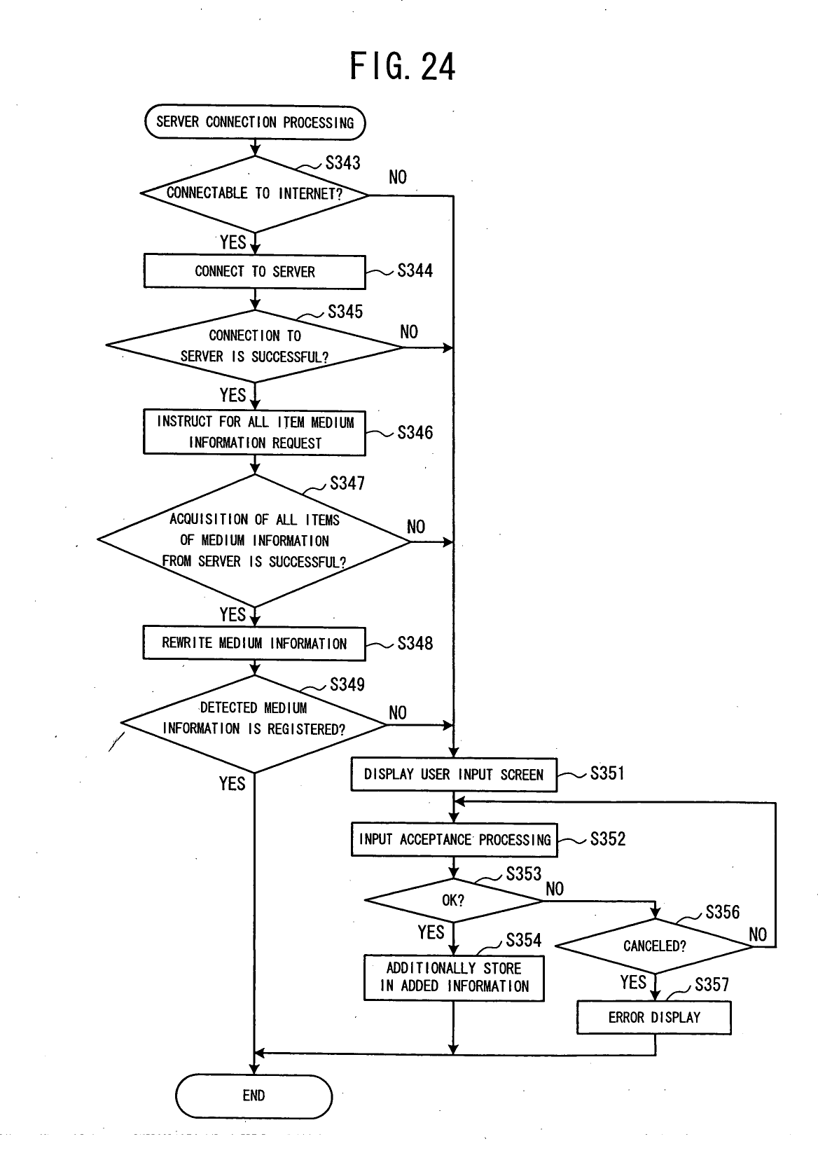

The main processing of the print apparatus 1 of the second embodiment will be described with reference to the flowcharts of FIGS. 23 and 24. The main processing shown in FIG. 23 is started when the print apparatus 1 is powered on. Then, initial processing, including initialization of the data area in the RAM 56 and an operation check of the print mechanism 20, is carried out (S301). A signal of the unit detection switch 58 is detected (S304). Whether the roll paper unit 70 is newly set up is determined depending on whether a sensor value of the roll paper unit 70 indicated by the detected signal is equal to a previously detected sensor value stored in the sensor value memory area 563 (S305). Here, when the print apparatus 1 is first started, the value of the sensor value memory area 563 is initialized in S301, it is determined that it is not equal (S305: NO) and the detected sensor value is stored in the sensor value memory area 563 (S306). Then, it is determined whether the roll paper unit 70 is a new medium (S307). With the sensor value stored in the sensor value column of the medium information memory area 564, this determination is performed based on whether any medium information is registered. If the medium information is registered, the roll paper unit 70 is not a new medium (S307: NO). Thus, the procedure proceeds to S310 without doing anything.

If the detected sensor value is not stored in the sensor value column of the medium information memory area 564, then it is determined to be a new roll paper unit 70 (S307: YES) and server connection processing is carried out (see S308 detailed in FIG. 24). If no roll paper unit 70 is set when the print apparatus 1 is started up, the same value as an initialization value “0000” in the sensor value memory area 563 is obtained because no unit detection switch 58 is pressed. In this case, the value would be determined to be the same as the sensor value stored in the sensor value memory area 563 (S305: YES), as an initialized value and the procedure would proceed to S310 without doing anything. If the execution of printing is instructed using key input (S310: YES), print would normally be executed (S311). However, in the case where no roll paper unit 70 is present, a subroutine (not shown or described) rejects, or does not execute, the print instruction. If the print instruction is not dispatched (S310: NO), other processing is carried out (S316).

The procedure returns to S304, in which a signal of the unit detecting switch 58 is detected (S304). If the sensor value for the roll paper unit 70 indicated by the signal detected here is the same as the previous detected sensor value stored in the sensor value memory area 563 (S305: YES), a determination whether it is a new roll paper unit 70 and its corresponding processings (S306 to S308) are not carried out. Thus, the procedure proceeds to S310 without doing anything, and then either the print processing (S311) and the other processing (S316) are executed depending upon whether a print instruction exists. Then, the procedure returns to S304, in which these processings (S304 to S316) are repeated.

Next, server connection processing (S308) will be described with reference to the flowchart of FIG. 24. First, whether a setting for connecting to the Internet 350 is made is determined (S343) and if the setting is made (S343: YES), the connection processing to the server 300 is carried out based on information stored in the ROM 55 (S344). If the connection to the server 300 is made (S345: YES), a signal is transmitted (S346) to the server 300 requesting all items of the medium information. If the medium information is acquired from the server 300 (S347: YES), the acquired medium information is rewritten (overwritten) to the medium information memory area 564 (S348). Then, whether the medium information of the detected roll paper unit 70 exists in the medium information memory area 564, that has just been acquired, is determined (S349) and if such information exists (S349: YES), the server connection processing is terminated.

If the setting for connecting to the Internet 350 is not made (S343: NO), the connection to the server 300 is not attained (S345: NO), no medium information can be obtained from the server 300 (S347: NO), or no medium information of the roll paper unit 70 is contained in acquired medium information (S349: NO), user input processing for inputting each item of the medium information by the user is carried out (S351 to S357). Then, the new roll paper unit information input screen (not shown, but the input items are the same as the new roll paper unit information input screen 500 shown in FIG. 11) is displayed on the display 54 (S351). Then, input acceptance processing for the input items of the new roll paper unit information input screen is carried out (S352) and if the OK button is selected (S353: YES), the inputted medium information is added to and stored in the medium information memory area 564 (S354). If the OK button is not selected (S353: NO) and the Cancel button is selected (S356: YES), an acquisition error screen (not shown) is displayed on the display 54 (S357) and the server connection processing is terminated. If neither the OK button nor the Cancel button is selected (S353: NO, S356: NO), the procedure returns to S352, in which repetitive input acceptance processing and acceptance processing of the OK button and Cancel button (S352, S353, S356) are carried out. Then, if the OK button is selected (S353: YES), the medium information is added to and stored in the medium information memory area 564 (S354), and the server connection processing is terminated.

Accordingly, when a new roll paper unit 70 is detected in the print apparatus 1 which also edits print data, it is connected to the server 300 to obtain medium information. If it cannot be connected to the server 300, user input is enabled.

The second embodiment is not restricted to the above-described embodiments but may be modified in various ways. For example, the information acquired from the server 300 may not be all piece medium information or may be medium information of the detected roll paper unit 70. In this case, in S346 of the server connection processing shown in FIG. 24, rather than a signal requesting the medium information of all items, a signal requesting only a specific medium information (medium information of a detected roll paper unit 70) is transmitted and the specified medium information is sent back from the server 300.

In a print apparatus 1 having no function for connecting to the server 300, it is permissible to execute only user input without connecting to the server 300. In this case, if it is determined to be a new medium in S307 (see FIG. 23) of the main processing, only the processings of S351 to S357 of the server connection processing shown in FIG. 24 are carried out.

The disclosure is not restricted to the above-described embodiments but may be modified in various ways. Although according to the above-described embodiments, the print apparatus 1 is employed as “print apparatus”, the “print apparatus” is not restricted to one printing a tape loaded on a roll paper unit but may be a print apparatus which prints a tape, cut paper, continuous paper and the like loaded on a cassette and the print method applied by the print apparatus may be an ink jet type, a laser type or the like. Then, respective items about medium information only have to correspond to a printing object medium or a print apparatus. Although according to the first embodiment, the personal computer 200 is employed as “print data creating unit”, the “print data creating unit” is not limited to the personal computer 200, but may be another type computer.

The print system, print data editing unit and print apparatus of the disclosure can be applied to a personal computer or the like for creating print data which allows the print apparatus to print and/or a print apparatus which creates print data itself.

As described above, according to the print system of the disclosure, the editing unit side medium information memory means of the print data editing unit stores medium information concerning a printing object medium to be printed by the print apparatus and the editing unit side medium information transmitting means transmits the medium information stored in the editing unit side medium information memory means to the print apparatus. Further, the print apparatus side medium information memory means of the print apparatus stores medium information and the print apparatus side medium information receiving means receives medium information transmitted from the editing unit side medium information transmitting means and the medium information memory control means stores the medium information received by the print apparatus side medium information receiving means in the print apparatus side medium information memory means. Thus, the print apparatus receives medium information of a new printing object medium and modified medium information from the print data editing unit and, as a consequence, the new printing object medium can be printed so as to enable maintenance of the medium information to be carried out.

According to the print system, the printing object medium detecting means of the print apparatus detects the type of a printing object medium loaded on the print apparatus and the detection medium discriminating means determines whether the medium information of a printing object medium of a type detected by the printing object medium detecting means is stored in the print apparatus side medium information memory means, and the all item request information transmitting means, if it is determined that it is not stored by the detection medium discriminating means, transmits all item request information requesting all pieces of the medium information to the print data editing unit. The all item request information receiving means of the print data editing unit receives the all item request information transmitted from the all item request information transmitting means, and the all item medium information transmission control means, if the all item information receiving means receives the all item request information, controls the transmission of all items of the medium information stored in the editing unit side medium information memory means by the editing unit side medium information transmitting means. Thus, all items of the medium information can be acquired from the print data editing unit even if the print apparatus has no medium information. As a consequence, a new printing object medium can be printed. Further, because the all items of the medium information are acquired, other medium information pieces which are not stored in the print apparatus but are stored in the print data editing unit can be acquired at the same time.

According to the print system, the printing object medium detecting means of the print apparatus detects the type of a printing object medium loaded on the print apparatus, the detection medium discriminating means determines whether the medium information of a printing object medium of a type detected by the printing object medium detecting means is stored in the print apparatus side medium information memory means, and the shortage request information transmitting means can, if it is determined that the medium information is not stored by the detection medium discriminating means, transmit short medium information requesting for short medium information that is the medium information not stored to the print data editing unit. Further, the shortage request information receiving means of the print data editing unit receives the shortage request information transmitted from the shortage request information transmitting means, the extracting means extracts the short medium information requested by the shortage request information received by the shortage request information receiving means from the medium information stored in the editing unit side medium information memory means, and the short medium information transmission control means can transmit the medium information extracted by the extracting means to the print apparatus side medium information receiving means using the editing unit side medium information transmitting means. Consequently, the medium information can be acquired from the print data editing unit even if the print apparatus has no medium information. Further, because only short medium information is acquired from the print data editing unit, updating time with the print data editing unit can be minimized.

According to the print system, the input means of the print data editing unit inputs medium information, the input medium information memory control means stores input medium information that is medium information inputted by the input means into the editing unit side medium information memory means and the first input control means and, if any short medium information is not extracted by the extracting means, actuates the input means. Consequently, an operator can input information even if no short medium information exists in the print data editing unit and, thus, the short medium information can be created so that the printing object medium can be printed.

According to the print system, the connection information memory means of the print data editing unit stores connection information for connecting to a server providing the medium information, the connecting means connects to the server using the connection information stored in the connection information memory means, the medium information acquiring means is connected to the server by the connecting means to acquire medium information and the short medium information acquisition control means can, if any short medium information is not extracted by the extracting means, acquire the short medium information from the server with the medium information acquiring means. Consequently, even if no short medium information exists in the print data editing unit, the short medium information can be acquired by connecting to a server through which a print medium providing company or a printing object medium providing company provides the medium information. Further, because the medium information which is acquired from the server is only the short medium information, connection time between the server and the print data editing unit can be minimized.

According to the print system, the connection information memory means of the print data editing unit stores connection information for connecting to a server providing the medium information, the connecting means connects to the server using the connection information stored in the connection information memory means, the medium information acquiring means is connected to the server by the connecting means to acquire the medium information, and the all item medium information acquisition control means can, if any short medium information is not extracted by the extracting means, acquire all pieces of the medium information from the server with the medium information acquiring means. Consequently, even if no short medium information exists in the print data editing unit, the short medium information can be acquired by connecting to a server through which a print medium providing company or a printing object medium providing company provides the medium information. Further, because the all items of the medium information can be acquired from the server, other medium information not stored in the print data editing unit can be acquired at the same time.

According to the print system, the input means of the print data editing unit inputs the medium information and the second input control means can, if any medium information fails to be acquired by the medium information acquiring means, actuate the input means. Consequently, even if no medium information exists in the server or the server cannot be connected, the operator can input the information and, thus, the short medium information is created so that the printing object medium can be printed.

According to the print system, the medium information memory control means of the print apparatus can, if the print apparatus side medium information receiving means receives the medium information transmitted from the editing unit side medium information transmitting means, store all pieces of the medium information received in the print apparatus side medium information memory means. Consequently, the received medium information can be stored as it is.

According to one embodiment of the print system, the individual medium information discriminating means of the print apparatus can, if the print apparatus side medium information receiving means receives medium information transmitted from the editing unit side medium information transmitting means, determine whether individual medium information, that is medium information of each printing object medium contained in the medium information received by the print apparatus side medium information receiving means, exists in the medium information stored in the print apparatus side medium information memory means. The medium information memory control means can add and store only individual medium information determined not to exist in the medium information stored in the print apparatus side medium information memory means by the individual information discriminating means in the print apparatus side medium information memory means. Consequently, only the medium information which is not stored in the print apparatus and needs to be newly stored can be stored.

According to another embodiment of the print system, the print apparatus side medium information transmitting means of the print apparatus can transmit all pieces of the medium information stored in the print apparatus side medium information memory means to the print data editing unit. The editing unit side medium information receiving means of the print data editing unit receives the medium information transmitted from the print apparatus side medium information transmitting means and the individual medium information discriminating means determines whether the individual medium information contained in the medium information stored in the editing unit side medium information memory means exists in the medium information received by the print apparatus side medium information receiving means. The individual medium information transmission control means can, if the individual medium information determined not to exist by the individual information discriminating means exits, transmit the individual medium information or all pieces of the medium information with the editing unit side medium information transmitting means. Consequently, because the print data editing unit can recognize which medium information is stored in the print apparatus and whether any medium information is short in the print apparatus by comparing with the medium information stored therein. Further because the short medium information or all items of the medium information are transmitted to the print apparatus, the short medium information can be added to the medium information of the print apparatus.

According to the print apparatus of the disclosure, the print apparatus side medium information memory means stores the medium information, the print apparatus side medium information receiving means receives medium information transmitted from the editing unit side medium information transmitting means and the medium information memory control means can store the medium information received by the print apparatus side medium information receiving means in the print apparatus side medium information memory means. Consequently, the medium information of a new printing object medium or modified medium information can be received from the print data editing unit and, thus, the new printing object medium can be printed. Further, maintenance of the medium information can be executed.

According to the print apparatus, the printing object medium detecting means detects the type of printing object medium loaded on the print apparatus, a detection medium discriminating means determines whether the medium information of the printing object medium of a type detected by the printing object medium detecting means is stored in the print apparatus side medium information memory means and the request information transmitting means can, if it is determined that the medium information is not stored by the detection medium discriminating means, transmit all item request information for requesting the print data editing unit for all pieces of the medium information or shortage request information for requesting for short medium information that is medium information not stored. Consequently, even if no medium information exists in the print apparatus, the short medium information or all pieces of the medium information stored in the print data editing unit can be requested from the print data editing unit and, thus, medium information transmitted from the print data editing unit can be acquired.

According to the print apparatus, if the print apparatus side medium information receiving means receives the medium information transmitted from the print data editing unit, the medium information memory control means can store all pieces of the received medium information in the print apparatus side medium information memory means. Thus, the received medium information can be stored as it is.

According to the print apparatus, the individual medium information discriminating means can, if the print apparatus side medium information receiving means receives medium information transmitted from the print data editing unit, determine whether individual medium information of each printing object medium of the medium information received by the print apparatus side medium information receiving means exists in the medium information stored in the print apparatus side medium information memory means. The medium information memory control means can add and store only individual medium information determined not to exist in the medium information stored in the print apparatus side medium information memory means by the individual medium information discriminating means to and in the print apparatus side medium information memory means. Thus, only the medium information which is not stored but needs to be newly stored can be stored.

According to the print apparatus, the print apparatus side medium information transmitting means can transmit all pieces of the medium information stored in the print apparatus side medium information memory means to the print data editing unit. Thus, because the print data editing unit can recognize which medium information is stored in the print apparatus, whether there is any short medium information in the print apparatus can be determined by comparing with the medium information stored therein. Further, because the short medium information or all pieces of the medium information are transmitted to the print apparatus, the short medium information can be added to the medium information in the print apparatus.

According to the print data editing unit of the disclosure, the editing unit side medium information memory means stores medium information concerning a printing object medium to be printed by the print apparatus and the editing unit side medium information transmitting means can transmit the medium information stored in the editing unit side medium information memory means to the print apparatus. Thus, the medium information stored in the print data editing unit can be reflected in the print apparatus.

According to the print data editing unit, the all item request information receiving means receives all item request information requesting all pieces of the medium information from the print apparatus and the all item medium information transmission control means can, if the all item request information receiving means receives an all item request information, transmit all items of the medium information stored in the editing unit side medium information memory means using the editing unit side medium information transmitting means.

According to the print data editing unit, the shortage request information receiving means receives shortage request information requesting short medium information that is a medium information transmitted from the shortage request information transmitting means and not stored in the print apparatus and the extracting means extracts the short medium information requested by the shortage request information received by the shortage request information receiving means from the medium information stored in the editing unit side medium information memory means and the short medium information transmission control means can transmit the medium information extracted by the extracting means to the print apparatus side medium information receiving means using the editing unit side medium information transmitting means.

According to the print data editing unit, the input means inputs the medium information, the input medium information memory control means stores input medium information that is medium information inputted by the input means into the editing unit side medium information memory means and the input control means can, if the short medium information is not extracted by the extracting means, actuate the input means. Consequently, even if the requested medium information is not stored, the operator can input the medium information and, thus, the requested medium information can be created.

According to the print data editing unit, the connection information memory means stores connection information for connecting to a server providing the medium information, the connecting means connects to the server using the connection information stored in the connection information memory means, the medium information acquiring means is connected to the server by the connecting means to acquire the medium information and the short medium information acquisition control means can, if the short medium information is not extracted by the extracting means, acquire the short medium information from the server with the medium information acquiring means. Thus, even if a requested medium information is not stored, the requested medium information can be acquired by connecting to a server by which a print medium providing company or a printing object medium providing company can provide medium information, if such a requested medium information is stored in the server.

According to the print data editing unit, the connection information memory means stores connection information for connecting to a server providing the medium information, the connecting means connects to the server using the connection information stored in the connection information memory means, the medium information acquiring means is connected to the server by the connecting means to acquire the medium information and the all item medium information acquisition control means can, if the short medium information is not extracted by the extracting means, obtain all pieces of the medium information from the server with the medium information acquiring means. Thus, even if a requested medium information is not stored, all items of the medium information stored in the server can be acquired by connecting to a server in which a print medium providing company or a printing object medium providing company provides medium information, if there is such requested medium information in the server.

According to the print data editing unit, the input means inputs the medium information and if any medium information fails to be acquired by the medium information acquiring means, the input means can be actuated. Thus, even if there is no medium information in the server or the server cannot be connected, the short medium information can be created because the operator can input the information.

According to the print data editing unit, the editing unit side medium information receiving means receives the medium information transmitted from the print apparatus, the second individual medium information discriminating means determines whether individual medium information of each printing object medium for the medium information stored in the editing unit side medium information memory means exists in the medium information received by the print apparatus side medium information receiving means and the individual medium information transmission control means can, if the individual medium information determined not to exist by the second individual medium information discriminating means exists, transmit the individual medium information or all pieces of the medium information with the editing unit side medium information transmitting means. Thus, because the medium information which is stored in the print apparatus can be recognized, whether there is any short medium information in the print apparatus can be determined by comparing with medium information stored therein, so that the short medium information can be added to the medium information in the print apparatus by transmitting the short medium information or all pieces of the medium information to the print apparatus.

According to the print apparatus of the disclosure, the medium information memory means stores medium information concerning a printing object medium to be printed by the print apparatus, the printing object medium detecting means detects the type of printing object medium loaded on the print apparatus, the detection medium discriminating means determines whether the medium information of the printing object medium of the type detected by the printing object medium detecting means is stored in the medium information memory means, the input means inputs the medium information, the inputted medium information memory control means stores an inputted medium information that is a medium information inputted by the input means into the medium information memory means and the input control means can, if it is determined that it is not stored by the detection medium discriminating means, actuate the input means. Thus, because the medium information can be created by an operator inputting the information of the printing object medium, the printing object medium can be printed.

According to the print apparatus of the disclosure, the medium information memory means stores medium information concerning a printing object medium to be printed by the print apparatus, the printing object medium detecting means detects the type of a printing object medium loaded on the print apparatus, the detection medium discriminating means determines whether the medium information of the printing object medium of a type detected by the printing object medium detecting means is stored in the medium information memory means, the connection information memory means stores connection information for connecting to a server providing the medium information, the connecting means connects to the server using the connection information stored in the connection information memory means, the medium information acquiring means is connected to the server by the connecting means to acquire the medium information and the short medium information acquisition control means can, if it is determined that it is not stored by the detection medium discriminating means, acquire the short medium information from the server with the medium information acquiring means. Thus, by connecting to a server in which a print medium providing company or a printing object medium providing company provides medium information on a network, the medium information of the printing object medium stored in the server can be acquired. Further, because the medium information acquired from the server is only medium information, the connecting time between the server and the print apparatus can be minimized.

According to the print apparatus of the disclosure, the medium information memory means stores medium information concerning a printing object medium to be printed by the print apparatus, the printing object medium detecting means detects the type of printing object medium loaded on the print apparatus, the detection medium discriminating means determines whether the medium information of the printing object medium of the type detected by the printing object medium detecting means is stored in the medium information memory means, the connection information memory means stores connection information for connecting to a server providing the medium information, the connecting means connects to the server using the connection information stored in the connection information memory means, the medium information acquiring means is connected to the server by the connecting means to acquire the medium information and the all item medium information acquisition control means can, if it is determined that the medium information is not stored by the detection medium discriminating means, acquire all pieces of the medium information from the server with the medium information acquiring means. Thus, by connecting to a sever in which a print medium providing company or a printing object medium providing company provides medium information on a network, all items of the medium information stored on the server can be acquired. If the short medium information is stored in the server, the medium information can be acquired. Further, because the all items of the medium information are acquired, other medium information which is stored in the server but not stored in the print apparatus can be acquired.

According to the print apparatus, the input means inputs the medium information and the input control means can, if the medium information fails to be acquired by the medium information acquiring means, actuate the input means. Thus, even if there is no medium information in the server or the server cannot be connected, the short medium information is created because the operator can input that information and consequently the printing object medium can be printed.

According to the print apparatus, the medium information memory means stores all pieces of the medium information acquired from the server. Thus, received medium information can be stored as it is.

According to the print apparatus, the individual medium information discriminating means can determine whether individual medium information that is a medium information of each printing object medium contained in the medium information acquired from the server by the medium information acquiring means exists in the medium information stored in the medium information memory means. The medium information memory control means can add and store only individual medium information determined not to exist in the medium information stored in the medium information memory means by the individual medium information discriminating means in the medium information memory means. Thus, only the medium information which is not stored in the print apparatus but needs to be newly stored can be stored.

Although the invention has been described with reference to exemplary embodiments, it is to be understood that the invention is not limited to the exemplary embodiments or structures. Though the various elements of the exemplary embodiments are shown in various combinations and configurations, which are exemplary, other combinations and configurations, including more, less or only a single element, are also within the spirit and scope of the disclosure.

1. A print system in which a print data editing unit for creating print data for a print apparatus to print and the print apparatus are connected, wherein the print data editing unit comprises:
an editing unit side medium information memory that stores medium information concerning a printing object medium to be printed upon by the print apparatus; and
an editing unit side medium information transmitting device that transmits the medium information stored in the editing unit side medium information memory to the print apparatus, and the print apparatus comprises:
a print apparatus side medium information memory that stores the medium information;
a print apparatus side medium information receiving device that receives the medium information transmitted from the editing unit side medium information transmitting device; and
a medium information memory controller that controls the print apparatus side medium information memory to store the medium information received by the print apparatus side medium information receiving device.

2. The print system according to claim 1, wherein the print apparatus further comprises:
a printing object medium detector that detects the type of a printing object medium loaded on the print apparatus;
detection medium discriminating means for determining whether the medium information of a printing object medium of a type detected by the printing object medium detector is stored in the print apparatus side medium information memory; and
an all item request information transmitting device that, when it is determined that the medium information is not stored in the print apparatus side medium information memory by the detection medium discriminating means, transmits an all item request information requesting all pieces of medium information to the print data editing unit, and
the print data editing unit further comprises:
an all item request information receiving device that receives the all item request information transmitted from the all item request information transmitting device; and
an all item medium information transmission controller that, when the all item information receiving device receives the all item request information, controls the transmission of all items of the medium information stored in the editing unit side medium information memory by means of the editing unit side medium information transmitting device.

3. The print system according to claim 1, wherein the print apparatus further comprises:
a printing object medium detector that detects the type of a printing object medium loaded on the print apparatus;
detection medium discriminating means for determining whether the medium information of a printing object medium of a type detected by the printing object medium detector is stored in the print apparatus side medium information memory; and
a shortage request information transmitting device that, when it is determined that the medium information is not stored in the print apparatus side medium information memory by the detection medium discriminating means, transmits a short medium information requesting short medium information that is the missing medium information to the print data editing unit, and the print data editing unit further comprises:
a shortage request information receiving device that receives the shortage request information transmitted from the shortage request information transmitting device;
extracting means for extracting the short medium information requested by the shortage request information received by the shortage request information receiving device from the medium information stored in the editing unit side medium information memory; and
a short medium information transmission controller that transmits the medium information extracted by the extracting means to the print apparatus side medium information receiving device using the editing unit side medium information transmitting device.

4. The print system according to claim 3, wherein the print data editing unit further comprises:
an input device that is capable of inputting the medium information;
an input medium information memory controller that stores input medium information that is medium information inputted by the input device into the editing unit side medium information memory; and
a first input controller that, when the short medium information is not extracted by the extracting means, actuates the input device.

5. The print system according to claim 3, wherein the print data editing unit further comprises:
a connection information memory that stores connection information for connecting to a server providing the medium information;
a connection to the server using the connection information stored in the connection information memory;
medium information acquiring means, that is connected to the server by the connection, for acquiring the medium information; and
a short medium information acquisition controller that, when the short medium information is not extracted by the extracting means, acquires the short medium information from the server with the medium information acquiring means.

6. The print system according to claim 3, wherein the print data editing unit further comprises:
a connection information memory that stores connection information for connecting to a server providing the medium information;
a connection to the server using the connection information stored in the connection information memory;
medium information acquiring means, that is connected to the server by the connection, for acquiring the medium information; and
an all item medium information acquisition controller that, when the short medium information is not extracted by the extracting means, acquires all pieces of the medium information from the server with the medium information acquiring means.

7. The print system according to claim 5, wherein the print data editing unit further comprises:
an input device that is capable of inputting the medium information; and
an input controller that, when the medium information fails to be acquired by the medium information acquiring means, actuates the input device.

8. The print system according to claim 1, wherein the print apparatus, when the print apparatus side medium information receiving device receives the medium information transmitted from the editing unit side medium information transmitting device, the medium information memory controller stores all pieces of the medium information received in the print apparatus side medium information memory.

9. The print system according to claim 1, wherein the print apparatus further comprises individual medium information discriminating means for, when the print apparatus side medium information receiving device receives the medium information transmitted from the editing unit side medium information transmitting device, determining whether individual medium information that is medium information of each printing object medium contained in the medium information received by the print apparatus side medium information receiving device exists in the medium information stored in the print apparatus side medium information memory, and
the medium information memory controller adds and stores only individual medium information determined not to exist in the medium information stored in the print apparatus side medium information memory by the individual information discriminating means to and in the print apparatus side medium information memory.

10. The print system according to claim 1, wherein the print apparatus further comprises:
a print apparatus side medium information transmitting device that transmits all pieces of the medium information stored in the print apparatus side medium information memory to the print data editing unit, and
the print data editing unit further comprises:
an editing unit side medium information receiving device that receives the medium information transmitted from the print unit side medium information transmitting device;
individual medium information discriminating means for determining whether the individual medium information contained in the medium information stored in the editing unit side medium information memory exists in the medium information received by the editing unit side medium information receiving device; and
an individual medium information transmission controller that, when the individual medium information determined not to exist by the individual information discriminating means exists, directs transmitting of one of the individual medium information and all pieces of the medium information by the editing unit side medium information transmitting device.

11. A print apparatus connected to a print data editing unit for creating print data for the print apparatus to print, comprising:
a print apparatus side medium information memory that stores medium information;
a print apparatus side medium information receiving device that receives the medium information transmitted from the print data editing unit; and
a medium information memory controller that stores the medium information received by the print apparatus side medium information receiving device in the print apparatus side medium information memory.

12. The print apparatus according to claim 11, further comprising:
a printing object medium detector that detects the type of a printing object medium loaded on the print apparatus;
detection medium discriminating means for determining whether the medium information of a printing object medium of a type detected by the printing object medium detector is stored in the print apparatus side medium information memory; and
a request information transmitting device that, when it is determined that the medium information is not stored in the print apparatus side medium information memory by the detection medium discriminating means, transmits one of an all item request information requesting the print data editing unit for all pieces of the medium information and a shortage request information requesting short medium information for the medium information not stored.

13. The print apparatus according to claim 11, wherein when the print apparatus side medium information receiving device receives the medium information transmitted from the print data editing unit, the medium information memory controller stores all pieces of the medium information received in the print apparatus side medium information memory.

14. The print apparatus according to claim 11, further comprising individual medium information discriminating means for, when the print apparatus side medium information receiving device receives the medium information transmitted from the print data editing unit, determining whether individual medium information of each printing object medium of the medium information received by the print apparatus side medium information receiving device exists in the medium information stored in the print apparatus side medium information memory, and
the medium information memory controller adds and stores only individual medium information determined not to exist in the medium information stored in the print apparatus side medium information memory by the individual medium information discriminating means to and in the print apparatus side medium information memory.

15. The print apparatus according to claim 11, further comprising a print apparatus side medium information transmitting device that transmits all pieces of the medium information stored in the print apparatus side medium information memory to the print data editing unit.

16. A print data editing unit connected to a print apparatus for creating print data for the print apparatus to print, comprising:
an editing unit side medium information memory that stores medium information concerning a printing object medium to be printed upon by the print apparatus; and
an editing unit side medium information transmitting device that transmits the medium information stored in the editing unit side medium information memory to the print apparatus.

17. The print data editing unit according to claim 16, further comprising:
an all item request information receiving device that receives all item request information requesting all pieces of the medium information transmitted from the print apparatus; and
an all item medium information transmission controller that, when the all item request information receiving device receives the all item request information, controls the transmission of all items of the medium information stored in the editing unit side medium information memory using the editing unit side medium information transmitting device.

18. The print data editing unit according to claim 16, further comprising:
a shortage request information receiving device that receives shortage request information requesting short medium information, that is a medium information transmitted from the print apparatus, when the short medium information is not stored in the print apparatus;
extracting means for extracting the short medium information requested by the shortage request information received by the shortage request information receiving device from the medium information stored in the editing unit side medium information memory; and
a short medium information transmission controller that controls the transmission of the medium information extracted by the extracting means to the print apparatus by the editing unit side medium information transmitting device.

19. The print data editing unit according to claim 18, further comprising:
an input device capable of inputting the medium information;
an input medium information memory controller that stores input medium information, that is a medium information inputted by the input device, into the editing unit side medium information memory; and
an input controller that, when the short medium information is not extracted by the extracting means, actuates the input device.

20. The print data editing unit according to claim 18, further comprising:
a connection information memory that stores connection information for connecting to a server providing the medium information;
a connection that connects to the server using the connection information stored in the connection information memory;
medium information acquiring means, that is connected to the server by the connection, for acquiring the medium information; and
a short medium information acquisition controller that, when the short medium information is not extracted by the extracting means, acquires the short medium information with the medium information acquiring means.

21. The print data editing unit according to claim 18, further comprising:
a connection information memory that stores connection information for connecting to a server providing the medium information;
a connection that connects to the server using the connection information stored in the connection information memory;
medium information acquiring means, that is connected to the server by the connection, for acquiring the medium information; and
an all item medium information acquisition controller that, when the short medium information is not extracted by the extracting means, obtains all pieces of the medium information from the server by the medium information acquiring means.

22. The print data editing unit according to claim 20, further comprising an input device capable of inputting the medium information wherein when the medium information is not acquired by the medium information acquiring means, the input device is actuated.

23. The print data editing unit according to claim 16, further comprising:
an editing unit side medium information receiving device that receives the medium information transmitted from the print apparatus;
individual medium information discriminating means for determining whether individual medium information of each printing object medium for the medium information stored in the editing unit side medium information memory exists in the medium information received by the editing unit side medium information receiving device; and
an individual medium information transmission controller that, when the individual medium information determined not to exist by the individual medium information discriminating means exists, controls the transmission of one of the individual medium information and all pieces of the medium information by the editing unit side medium information transmitting device.

24. A print apparatus, comprising:
a medium information memory that stores medium information concerning a printing object medium to be printed upon by the print apparatus;
a printing object medium detector that detects the type of a printing object medium loaded on the print apparatus;
detection medium discriminating means for determining whether the medium information of the printing object medium of a type detected by the printing object medium detecting means is stored in the medium information memory;
an input device capable of inputting the medium information;
an inputted medium information memory controller that controls storing an inputted medium information that is a medium information inputted by the input device into the medium information memory; and
an input controller that, when it is determined that the medium information is not stored by the detection medium discriminating means, actuates the input device.

25. A print apparatus, comprising:
a medium information memory that stores medium information concerning a printing object medium to be printed upon by the print apparatus;
a printing object medium detector that detects the type of a printing object medium loaded on the print apparatus;
detection medium discriminating means for determining whether the medium information of the printing object medium of a type detected by the printing object medium detector is stored in the medium information memory;
a connection information memory that stores connection information for connecting to a server providing the medium information;
a connection to the server using the connection information stored in the connection information memory;
medium information acquiring means, that is connected to the server by the connection, for acquiring the medium information; and
a short medium information acquisition controller that, when it is determined that at least some medium information is not stored by the detection medium discriminating means, controls acquiring short medium information from the server with the medium information acquiring means.

26. A print apparatus, comprising:
a medium information memory that stores medium information concerning a printing object medium to be printed upon by the print apparatus;
a printing object medium detector that detects the type of a printing object medium loaded on the print apparatus;
detection medium discriminating means for determining whether the medium information of the printing object medium of a type detected by the printing object medium detector is stored in the medium information memory;
a connection information memory that stores connection information for connecting to a server providing the medium information;
a connection to the server using the connection information stored in the connection information memory;
medium information acquiring means, that is connected to the server by the connection, for acquiring the medium information; and
an all item medium information acquisition controller that, when it is determined that the medium information is not stored by the detection medium discriminating means, controls acquiring all pieces of the medium information from the server by the medium information acquiring means.

27. The print apparatus according to claim 25, further comprising:
an input device capable of inputting the medium information; and
an input controller that, when the medium information fails to be acquired by the medium information acquiring means, actuates the input device.

28. The print apparatus according to claim 25, wherein the medium information acquiring means stores all pieces of the medium information acquired from the server in the medium information memory.

29. The print apparatus according to claim 25, further comprising individual medium information discriminating means for determining whether individual medium information, that is a medium information of each printing object medium contained in the medium information acquired from the server by the medium information acquiring means, exists in the medium information stored in the medium information memory; and
a medium information memory controller that adds and stores only individual medium information determined not to exist in the medium information stored in the medium information memory by the individual medium information discriminating means to and in the medium information memory.

30. A print system in which a print data editing unit for creating print data for a print apparatus to print and the print apparatus are connected and further the print data editing unit and a server are connected, wherein the print data editing unit comprises:
an editing unit side medium information memory that stores medium information concerning a printing object medium to be printed upon by the print apparatus; and
an editing unit side medium information transmitting device that transmits the medium information stored in the editing unit side medium information memory to the print apparatus, and the print apparatus comprises:
a print apparatus side medium information memory that stores the medium information;
a print apparatus side medium information receiving device that receives the medium information transmitted from the editing unit side medium information transmitting device;
a medium information memory controller that controls the print apparatus side medium information memory to store the medium information received by the print apparatus side medium information receiving device;
a printing object medium detector that detects the type of a printing object medium loaded on the print apparatus;
detection medium discriminating means for determining whether the medium information of the printing object medium of a type detected by the printing object medium detector is stored in the print apparatus side medium information memory; and
a shortage request information transmitting device that, when it is determined that the medium information is not stored by the detection medium discriminating means, transmits short medium information requesting short medium information that is the medium information not stored in the print apparatus side medium information memory to the print data editing unit, and
the print data editing unit further comprises:
a shortage request information receiving device that receives the shortage request information transmitted from the shortage request information transmitting device;
extracting means for extracting the short medium information requested by the shortage request information received by the shortage request information receiving device from the medium information stored in the editing unit side medium information memory;
a short medium information transmission controller that controls transmission of the medium information extracted by the extracting means to the print apparatus side medium information receiving device by the editing unit side medium information transmitting device;
a connection information memory that stores connection information for connecting the medium information to a server;
a connection to the server using the connection information stored in the connection information memory;
medium information acquiring means, that is connected to the server by the connection, for acquiring the medium information; and
a short medium information acquisition controller that, when the short medium information is not extracted by the extracting means, controls acquiring the short medium information from the server by the medium information acquiring means.

31. The print system according to claim 30, wherein the print data editing unit further comprises:
an input device capable of inputting the medium information; and
an input controller that, when the medium information fails to be acquired by the medium information acquiring means, actuates the input device.

32. A print system in which a print data editing unit for creating print data for a print apparatus to print and the print apparatus are connected and further the print data editing unit and a server are connected, wherein the print data editing unit comprises:
an editing unit side medium information memory that stores medium information concerning a printing object medium to be printed upon by the print apparatus; and
an editing unit side medium information transmitting device that transmits the medium information stored in the editing unit side medium information memory to the print apparatus, and the print apparatus comprises:
a print apparatus side medium information memory that stores the medium information;
a print apparatus side medium information receiving device that receives the medium information transmitted from the editing unit side medium information transmitting device;
a medium information memory controller that controls storing, in the print apparatus side medium information memory, of the medium information received by the print apparatus side medium information receiving device;
a printing object medium detector that detects the type of a printing object medium loaded on the print apparatus;
detection medium discriminating means for determining whether the medium information of a printing object medium of a type detected by the printing object medium detector is stored in the print apparatus side medium information memory; and
a shortage request information transmitting device that, when it is determined that the medium information is not stored in the print apparatus side medium information by the detection medium discriminating means, transmits short medium information requesting short medium information that is the medium information not stored to the print data editing unit; and
the print data editing unit further comprises:
a shortage request information receiving device that receives the shortage request information transmitted from the shortage request information transmitting device;
extracting means for extracting the short medium information requested by the shortage request information received by the shortage request information receiving device from the medium information stored in the editing unit side medium information memory;
a short medium information transmission controller that controls transmitting the medium information extracted by the extracting means to the print apparatus side medium information receiving device by the editing unit side medium information transmitting device,
a connection information memory that stores connection information for connecting to the server providing the medium information;
a connection to the server using the connection information stored in the connection information memory;
medium information acquiring means, that is connected to the server by the connection, for acquiring the medium information; and
an all item medium information acquisition controller that, when the short medium information is not extracted by the extracting means, controls acquiring all pieces of the medium information from the server by the medium information acquiring means.

33. The print system according to claim 32, wherein the print data editing unit further comprises:
an input device capable of inputting the medium information; and
an input controller that, when the medium information fails to be acquired by the medium information acquiring means, actuates the input device.

34. A print data editing unit to be used in a system in which a print data editing unit for creating print data for a print apparatus to print and the print apparatus are connected and further the print data editing unit and a server are connected, comprising:
an editing unit side medium information memory that stores medium information concerning a printing object medium to be printed upon by the print apparatus;
an editing unit side medium information transmitting device that transmits the medium information stored in the editing unit side medium information memory to the print apparatus;
a shortage request information receiving device that receives shortage request information requesting short medium information, that is a medium information transmitted from the print apparatus and is not stored in the print apparatus;
extracting means for extracting the short medium information requested by the shortage request information received by the shortage request information receiving device from the medium information stored in the editing unit side medium information memory;
a short medium information transmission controller that controls transmitting the medium information extracted by the extracting means to the print apparatus by the editing unit side medium information transmitting device;
a connection information memory that stores connection information for connecting to the server providing the medium information;
a connection to the server using the connection information stored in the connection information memory;
medium information acquiring means, that is connected to the server by the connection, for acquiring the medium information; and
a short medium information acquisition controller that, when the short medium information is not extracted by the extracting means, controls acquiring the short medium information from the server by the medium information acquiring means.

35. The print data editing unit according to claim 34, further comprising an input device capable of inputting the medium information, wherein when the medium information fails to be acquired by the medium information acquiring means, the input device is actuated.

36. The print data editing unit according to claim 34, further comprising:
an editing unit side medium information receiving device that receives the medium information transmitted from the print apparatus;
individual medium information discriminating means for determining whether individual medium information of each printing object medium of the medium information stored in the editing unit side medium information memory exists in the medium information received by the editing unit side medium information receiving device; and
an individual medium information transmission controller that, when the individual medium information determined not to exist in the medium information received by the individual medium information discriminating means exists in the editing unit side information memory, transmitting one of the individual medium information and all pieces of the medium information by the editing unit side medium information transmitting device.

37. A print data editing unit to be used in a system in which the print data editing unit, for creating print data for a print apparatus to print, and the print apparatus are connected and further the print data editing unit and a server are connected, the print data editing unit comprising:
an editing unit side medium information memory that stores medium information concerning a printing object medium to be printed upon by the print apparatus;
an editing unit side medium information transmitting device that transmits the medium information stored in the editing unit side medium information memory to the print apparatus;
a shortage request information receiving device that receives shortage request information requesting short medium information, that is a medium information transmitted from the print apparatus and is not stored in the print apparatus;
extracting means for extracting the short medium information requested by the shortage request information received by the shortage request information receiving device from the medium information stored in the editing unit side medium information memory;
a short medium information transmission controller that controls transmitting the medium information extracted by the extracting means to the print apparatus by the editing unit side medium information transmitting device;
a connection information memory that stores connection information for connecting to the server providing the medium information;
a connection to the server using the connection information stored in the connection information memory;
medium information acquiring means, that is connected to the server by the connection, for acquiring the medium information; and
an all item medium information acquisition controller that, when the short medium information is not extracted by the extracting means, controls acquiring all pieces of the medium information from the server by the medium information acquiring means.

38. The print data editing unit according to claim 37, further comprising an input device capable of inputting the medium information, wherein when the medium information is not acquired by the medium information acquiring means, the input device is actuated.

39. The print data editing unit according to claim 37, further comprising:
an editing unit side medium information receiving device that receives the medium information transmitted from the print apparatus;
individual medium information discriminating means for determining whether individual medium information of each printing object medium of the medium information stored in the editing unit side medium information memory exists in the medium information received by the editing unit side medium information receiving device; and
an individual medium information transmission controller that, when the individual medium information determined not to exist by the individual medium information discriminating means exists, controls transmitting one of the individual medium information and all pieces of the medium information by the editing unit side medium information transmitting device.

40. A print apparatus to be used in a system in which the print apparatus and server are connected, comprising:
a medium information memory that stores medium information concerning a printing object medium to be printed by the print apparatus;
a printing object medium detector that detects the type of a printing object medium loaded on the print apparatus;
detection medium discriminating means for determining whether the medium information of the printing object medium of a type detected by the printing object medium detector is stored in the medium information memory;
a connection information memory that stores connection information for connecting to the server providing the medium information;
a connection to the server using the connection information stored in the connection information memory;
medium information acquiring means, that is connected to the server by the connection, for acquiring the medium information; and
a short medium information acquisition controller that, when it is determined that at least some medium information is not stored by the detection medium discriminating means, controls acquiring the short medium information from the server with the medium information acquiring means.

41. The print apparatus according to claim 40, further comprising:
an input device capable of inputting the medium information; and
an input controller that, when the medium information fails to be acquired by the medium information acquiring means, actuates the input device.

42. The print apparatus according to claim 40, wherein the medium information acquiring means stores all pieces of the medium information acquired from the server in the medium information memory.

43. The print apparatus according to claim 40, further comprising individual medium information discriminating means for determining whether individual medium information that is a medium information of each printing object medium contained in the medium information acquired from the server by the medium information acquiring means exists in the medium information stored in the medium information memory, wherein the medium information memory controller adds and stores only individual medium information determined not to exist in the medium information stored in the medium information memory by the individual medium information discriminating means to and in the medium information memory means.

44. A print apparatus to be used in a system in which the print apparatus and server are connected, comprising:
a medium information memory that stores medium information concerning a printing object medium to be printed upon by the print apparatus;
a printing object medium detector that detects the type of a printing object medium loaded on the print apparatus;
detection medium discriminating means for determining whether the medium information of the printing object medium of a type detected by the printing object medium detector is stored in the medium information memory;
a connection information memory that stores connection information for connecting to the server providing the medium information;
a connection to the server using the connection information stored in the connection information memory;
medium information acquiring means, that is connected to the server by the connection, for acquiring the medium information; and
an all item medium information acquisition controller that, when it is determined that the medium information is not stored by the detection medium discriminating means, controls acquiring all pieces of the medium information from the server by the medium information acquiring means.

45. The print apparatus according to claim 44, further comprising:
an input device capable of inputting the medium information; and
an input controller that, when the medium information fails to be acquired by the medium information acquiring means, actuates the input device.

46. The print apparatus according to claim 44, wherein the medium information acquiring means stores all pieces of the medium information acquired from the server in the medium information memory.

47. The print apparatus according to claim 44, further comprising individual medium information discriminating means for determining whether individual medium information that is a medium information of each printing object medium contained in the medium information acquired from the server by the medium information acquiring means exists in the medium information stored in the medium information memory, wherein the medium information memory controller adds and stores only individual medium information determined not to exist in the medium information stored in the medium information memory by the individual medium information discriminating means to and in the medium information memory.
